(19) United States
(12) Patent Application Publication
(10) Pub. No.: US 2017/0349419 A1
(43) Pub. Date: Dec. 7, 2017

(54) GANTRY TOWER CRANE FOR INSPECTING CARGO HOLD

(71) Applicant: DAEWOO SHIPBUILDING & MARINE ENGINEERING CO., LTD., Seoul (KR)

(72) Inventors: Jeong Hyeong LEE, Bucheon-si Gyeonggi-do (KR); Dong Ho KIM, Gunpo-si Gyeonggi-do (KR); Ju Yi PARK, Ansan-si Gyeonggi-do (KR); Dong Su KIM, Yongin-si Gyeonggi-do (KR); Jin Cheol HONG, Gimpo-si Gyeonggi-do (KR)

(73) Assignee: DAEWOO SHIPBUILDING & MARINE ENGINEERING CO., LTD, Seoul (KR)

(21) Appl. No.: 15/539,439

(22) PCT Filed: Jun. 9, 2015
(86) PCT No.: PCT/KR2015/005785

§ 371 Date: Jun. 23, 2017

(30) Foreign Application Priority Data
Dec. 24, 2014 (KR) 10-2014-0189016

(51) Int. Cl. B66F 11/04; B63B 9/00; B63C 5/02

(52) U.S. Cl. CPC B66F 11/04; B63C 5/02; B63B 9/00; B63C 2005/025

(57) ABSTRACT

The present invention relates to a gantry tower crane for inspecting a cargo hold, comprising: two running rails which are installed to be spaced apart from each other in the longitudinal direction of the cargo hold; two prefabricated towers, each of which are installed to be able to move along respective running rails; and a basket which is installed to be able to move up and down along the prefabricated towers. Thus, as the basket installed in the prefabricated towers is installed to have a variable length and to be rotatable, it is possible to inspect both wall surfaces and a ceiling of the cargo hold, and to inspect the wall surfaces while moving along an overpass. Also, it is possible to obtain an effect of being able to perform inspection more precisely in a state where an operator comes closer to the wall surfaces by extending an auxiliary foothold of the overpass.

### TECHNICAL FIELD

The present invention relates to a gantry tower crane for inspecting a cargo hold, and more particularly, to a gantry tower crane for inspecting a cargo hold, capable of inspecting or maintaining and repairing an inside of the cargo hold of a large ship, such as a container ship, an LNG carrier, and a floating liquefied natural gas (FLNG).

### BACKGROUND ART

In general, natural gas is transported in a gaseous state via land or sea gas piping, or stored in a LNG carrier in the form of liquefied natural gas (hereinafter referred to as “LNG”) so as to be transported to a remote source of demand.

A ship for carrying LNG is broadly classified into a moss type ship and a membrane type ship, in which the moss type LNG carrier has a structure that more than half of a cargo hold having a generally spherical shape protrudes to the outside of the carrier, and the membrane type LNG carrier has a structure that a membrane type cargo hold is provided inside the carrier or only a part of the membrane type cargo hold protrudes to the outside of the carrier.

In the case of the membrane type LNG carrier, since most or all of the cargo holds are provided inside the carrier and basically have a rectangular structure, more LNG can be transported compared to the moss type LNG carrier, and influence of wind can be minimized, so that the sailing performance is also considered excellent.

Since the membrane type cargo hold has no support or structure inside the cargo hold due to structural characteristics of the membrane type cargo, scaffolds (mold) are installed by connecting each material one by one to inspect the gas leakage and the membrane damage in the cargo hold, or to perform the maintenance and repair work, and the installation time for such scaffolds is excessively required.

In addition, after all the scaffolds (molds) are removed as the cargo hold is constructed, if the maintenance and repair work or the inspection work for the membrane is required, a foothold (scaffold or mold) has to be installed and dismantled again, resulting in significant process disruptions.

In the case of typical LNG carriers, the LNG carriers are repaired at a repair shipyard for the maintenance and repair or the inspection of the cargo hold and other tools and materials every five-year cycle. At this time, it is possible to perform the inspection work and the maintenance and repair work by installing the mold in the cargo hold due to the time margin.

However, in the case of an ocean platform that has to stay at sea for a long time, such as floating liquefied natural gas (FLNG), since it is not possible to move the ocean platform to the repair shipyard, it is necessary to perform inspection, maintenance, and repair on the inside of the cargo hold in a state of floating on the sea. Thus, it takes a long time for the inspection, maintenance, and repair work.

In addition, if the inspection, maintenance, and repair work for the cargo hold is stopped, it causes a great economic loss, so that a method of rapidly performing inspection, maintenance and repair work is required other than the conventional method of installing a scaffold (mold).

As described above, since the scaffolds are installed manually when inspecting and repairing the inside of large ships and warehouses, it takes much installation work time. In addition, since there is no separate safety device, there is always a risk of safety accidents caused by mistake such as falling during work, and since it takes much time to dismantle the scaffold after completing the inspection and maintenance work, the manufacturing and inspection costs are raised.

In addition, since there is no support inside the cargo hold of the membrane type LNG carriers, in order to inspect the gas leakage, the membrane damage, and the insulation box damage in the cargo hold, or to perform the maintenance and repair work, a gas dome, which is the only passage to the inside of the cargo hold, is used to insert materials, and each material is connected one by one to install the mold. Therefore, the installation and dismantling time is excessively required, and much workforce is necessary.

In particular, if the maintenance and repair work for the inside of the cargo hold is inevitably necessary after dismantling the mold, it requires much time and workforce to install the mold, which may lead to serious process disruptions.

In addition, although a method of installing a multi-joint robot in the gas dome has been proposed, in order to cover the whole area of the cargo hold, the total length of the multi-joint robot has to be 30 m or more, which is large, and the robot has to be manufactured robust enough to allow an operator to safely ride on the end of the robot.

In the case of applying such a multi-joint robot system to an ocean plant such as FLNG, since it is difficult for a long structure or structures having large diameters to enter due to constraints of a space between a top side and a main deck, installation is difficult in reality.

For example, Patent Document 1 discloses a ‘movable scaffold structure for working in a cargo hold of a liquefied natural gas carrier’.

The movable scaffold structure for working in the cargo hold of the liquefied natural gas carrier according to Patent Document 1 includes: a base body part for supporting a scaffold structure installed in the cargo hold; a fixed leg part installed on a bottom surface of the base body part; a rotation leg part rotatably installed about a pivot point portion with respect to the fixed leg part; a support leg part having an auxiliary leg portion which is adjustable in length by using a telescopic connection portion with respect to the rotation leg part; and a rolling contact part installed on the support leg part to realize movement of the base body part.

The pivot point portion includes: a first mounting bracket coupled to one end of the fixed leg part; a second mounting bracket coupled to one end of the rotation leg part; a hinge pin coupled to share a hinge point of the first mounting bracket and the second mounting bracket; a plurality of coupling holes formed in the first mounting bracket and the second mounting bracket over a same radius around the hinge pin; and a fastening pin.

The telescopic connection portion includes an adjustment nut screw-coupled to a front end of the rotation leg part to restrain movement of the auxiliary leg portion inserted and fitted into the rotation leg part. In addition, the rolling contact part includes a wheel support horizontally installed at a lower front end of the auxiliary leg portion, and a plurality of rotation wheels installed in a longitudinal direction with respect to the wheel support.

Patent Document 2 discloses a ‘movable mold system of an LNG cargo hold’.

The movable mold system of the LNG cargo hold according to Patent Document 2 is a mold system provided in the LNG cargo hold and includes: a plurality of guide rails arranged along a longitudinal direction at a side portion of the cargo hold; a frame vertically installed to move along the guide rail; and a plurality of molds detachably coupled to the frame while being vertically spaced apart from each other.

### DISCLOSURE

### Technical Problem

Although the movable scaffold structure for working in the cargo hold of the liquefied natural gas carrier according to the related art may reduce the number of work processes required for installation and dismantling of the scaffold structure by minimizing an installation range of a multi-layer scaffold structure in the cargo hold, there is a problem that a large-sized cargo hold requires a large number of movable scaffold structure.

In addition, in the movable mold system of the LNG cargo hold according to the related art, there is inconvenience that the guide rail has to be fixed in the longitudinal direction along an inner wall surface of the cargo hold, it is inconvenient because the mold has to be installed at regular height intervals, and there is inconvenience due to the installation and dismantling of these movable mold frames.

To solve the problems described above, an object of the present invention is to provide a gantry tower crane for inspecting a cargo hold, capable of rapidly installing or dismantling the tower crane for checking, maintaining, repairing, and inspecting an inside of the cargo hold.

Another object of the present invention is to provide a gantry tower crane for inspecting a cargo hold, capable of ensuring safety of an operator when checking, maintaining, repairing, and inspecting the cargo hold.

Another object of the present invention is to provide a gantry tower crane for inspecting a cargo hold, capable of freely moving or rotating in vertical and horizontal directions such that the entire inside of the cargo hold may be inspected, maintained, and repaired.

Another object of the present invention is to provide a gantry tower crane for inspecting a cargo hold, capable of rapidly performing inspection, maintenance, and repair work of the cargo hold.

Another object of the present invention is to provide a gantry tower crane for inspecting a cargo hold, capable of installing or dismantling the gantry tower crane through a gas dome formed in an upper portion of the cargo hold.

Another object of the present invention is to provide a gantry tower crane for inspecting a cargo hold, which allows the operator to easily access an inner wall surface and a ceiling portion of the cargo hold.

### Technical Solution

To achieve the objects described above, according to the present invention, there is provided a gantry tower crane for inspecting a cargo hold, the gantry tower crane including: two running rails spaced apart from each other in a longitudinal direction of the cargo hold; two prefabricated towers movably mounted along the running rails, respectively; and a basket movable up and down along the prefabricated tower.

An overpass connected between the two prefabricated towers widthwise along the cargo hold may be further included.

The running rail may include: a rail body having a predetermined length and a predetermined width; a rack mounted on an upper surface of the rail body to allow the prefabricated tower to move; and a guide rail mounted in a same direction as the rack at a position spaced apart from the rack by a predetermined distance.

The running rail may include a plurality of moving wheels mounted on a bottom surface of the rail body so as to be movable along a floor surface of the cargo hold.

The rail body may include: a first coupling part coupled with another rail body adjacent to one side of the rail body; and a second coupling part coupled with another rail body adjacent to an opposite side of the rail body, wherein a plurality of rail bodies are coupled to each other by the coupling of the first and second coupling parts.

The first coupling part and the second coupling part are rotatably hinge-coupled to each other.

The prefabricated tower may include: a mobile platform movably mounted along the running rail; and a plurality of tower units vertically coupled to the mobile platform.

The mobile platform may include: a platform body having a predetermined size; a plurality of posts vertically fixed to an upper portion of the platform body such that the posts are coupled with the tower unit; and a plurality of pinion gears mounted on a bottom surface of the platform body such that the pinion gears are engaged with the rack so as to be movable along the running rail.

The mobile platform may include: a plurality of holes formed in the fixed post at predetermined intervals such that the mobile platform is rapidly coupled with the tower unit; and a pin fitted into the hole.

The mobile platform may include a guide roller guided by the guide rail by making close contact with a side surface of the guide rail such that the prefabricated tower is safely moved.

The guide roller may include: a guide member making close contact with the side surface of the guide rail; a movable member coupled to the guide member and movably mounted on a side surface of the platform body; and an adjustment bolt fastened to the movable member to change a position of the movable member.

The tower unit may include: a lower truss unit coupled to the mobile platform; at least one middle truss unit coupled to an upper portion of the lower truss unit; and an upper truss unit coupled to an uppermost end of the middle truss unit and provided with a passage for an operator.

The lower truss unit may include: a plurality of vertical frames having a predetermined length and configured in a rectangular shape; cross frames fixed between the vertical frames such that the cross frames cross the vertical frames at different directions; a plurality of fixing holes formed in a lower portion of the vertical frame such that the lower truss unit is fixedly fitted to the mobile platform; and a coupling hole formed on an upper portion of the vertical frame such that the lower truss unit is fitted to the middle truss unit.

The middle truss unit may include: a plurality of vertical frames having a predetermined length and configured in a rectangular shape; cross frames fixed between the vertical frames such that the cross frames cross the vertical frames at different directions; and a horizontal frame fixed to an end of the cross frame.

The middle truss unit may include a rotation bar rotatably and elastically mounted on the horizontal frame.

The prefabricated tower may include a fixing unit making close contact with an upper surface of the cargo hold to stably mount the tower unit.

The fixing unit may include: a fixing plate provided at a same size as the tower unit; a plurality of cylinders mounted on an upper surface of the fixing plate; and a winch mounted on the upper surface of the fixing plate.

The fixing unit may include a rotation plate rotatably mounted on an upper surface of the cylinder.

The rotation plate may include: a first plate fixed to the upper surface of the cylinder; a second plate rotatably provided on an upper surface of the first plate and coupled to a flat bearing; a third plate mounted on an upper surface of the second plate and formed therein with a groove to which the flat bearing is fitted; and a fourth plate mounted on an upper surface of the third plate and formed therein with a groove to which a tongue of the cargo hold is fitted.

The basket is rotatable in a horizontal direction and has a variable length with respect to a wall surface of the cargo hold.

The basket may include: an up-down movement frame mounted on an outer surface of the prefabricated tower so as to be movable up and down; a boom support rotatably mounted on one surface of the up-down movement frame and having a variable length; and a work table rotatably mounted at an end of the boom support.

The up-down movement frame may include: a first frame provided with a wheel so as to be movable along one surface of the prefabricated tower; a second frame coupled to the first frame and provided with a wheel so as to be movable along an opposite surface of the prefabricated tower; and a support frame protruding such that the boom support is rotatably mounted on one side of the second frame.

The boom support may include: a rotation boom support rotatably coupled to one side of the up-down movement frame; a plurality of movable boom supports movable in the rotation boom support in a telescopic manner; and a support bar rotatably mounted on one side of the up-down movement frame and the rotation boom support so as to stably support the rotation boom support.

The work table may include: a rotation railing rotatable about one side of the work table so as to communicate with the prefabricated tower; and an auxiliary railing rotated together with the rotation railing, provided on both sides of the rotation railing, and having a predetermined height.

The prefabricated tower may include: a mobile platform movably mounted along the running rail; and a plurality of tower units vertically coupled to the mobile platform.

The prefabricated tower may include a fixing unit making close contact with a ceiling of the cargo hold so as to stably mount the tower unit.

The overpass may include: a foothold serving as a path for an operator; a foothold support having a truss structure to stably support the foothold; and an auxiliary foothold rotatable toward an outside such that a work space extends on one side of the foothold.

The foothold may include: a foothold body rotatable about a hinge; and a rotation link provided at predetermined intervals on both sides of the foothold body.

The foothold is hinge-coupled so as to be folded or unfolded.

The foothold support may include: a first frame and a second frame provided at left and right sides of the foothold support at predetermined angles; two rotation rods rotatably coupled to one ends of the first and second frames in a longitudinal direction; and a connection rod fixed between the two rotation rods.

Each of the first and second frames may include: a first ring provided at upper ends of the first and second frames such that the railing frame is rotatably coupled; a second ring provided at a lower portion of the first ring such that the rotation link is rotatably coupled; and a third ring to which the rotation rod and the connection rod are rotatably coupled.

The auxiliary foothold may include: a railing frame rotatably coupled to upper sides of the first and second frames; and two railings detachably coupled to the railing frame.

The two railings may include: a first railing frame having a predetermined length; and a second railing frame movably coupled to an outer surface of the first railing frame.

One of the two railings may further include a work foothold provided to form the work space of the operator.

A chain connected between the two railings such that the two railings are stably fixed to each other may be included.

### Advantageous Effects

As described above, according to the gantry tower crane for inspecting the cargo hold of the present invention, the protective cover is provided on the floor surface of the cargo hold, so that the damage or breakage of the cargo hold can be prevented, the mobile platform, the tower unit, and the fixing unit are descended on an installation rail while being assembled, so that the installation is performed easily and rapidly, and baskets are installed in respective prefabricated towers, so that a wide work area (space) for the operator can be obtained.

According to the gantry tower crane for inspecting the cargo hold of the present invention, as the basket installed in the prefabricated towers is installed to have a variable length and to be rotatable, it is possible to inspect both wall surfaces and a ceiling of the cargo hold, and to inspect the wall surfaces while moving along an overpass. In addition, it is possible to obtain an effect of being able to perform inspection more safely and precisely in a state where an operator comes closer to the wall surfaces by extending an auxiliary foothold of the overpass.

According to a method for installing a gantry tower crane for use in cargo hold inspection, the tower units are descended by a unit descending device while assembling the tower units, so that the tower crane can be rapidly installed in a short time, components necessary for installing the tower crane can be stably inserted (lowered) through the gas dome, the time required to install two prefabricated towers can be reduced by installing the tower crane by the installation rail and then installing the running rail, and all zones of the cargo hold can be inspected as baskets and overpasses are installed.

According to a method for installing a gantry tower crane for use in cargo hold inspection, the installation state of the tower crane can be more stably maintained by connecting the two prefabricated towers with each other, and the two prefabricated towers can be moved, which allows to freely move the work area according to the inspection of the cargo hold.

### DESCRIPTION OF DRAWINGS

FIG. 1 is a perspective view showing a state before installing a running rail of a gantry tower crane for inspecting a cargo hold according to a preferred embodiment of the present invention.

FIG. 2 is a perspective view showing a state that the running rail of the gantry tower crane for inspecting the cargo hold according to the preferred embodiment of the present invention is installed.

FIG. 3 is a perspective view showing a protective cover of the gantry tower crane for inspecting the cargo hold according to the preferred embodiment of the present invention.

FIG. 4 is a perspective view showing a state that a mobile platform is installed on a rail of the gantry tower crane for inspecting the cargo hold according to the preferred embodiment of the present invention.

FIG. 5 is an exploded perspective view showing the rail of the gantry tower crane for inspecting the cargo hold according to the preferred embodiment of the present invention.

FIG. 6 is an exploded perspective view showing a prefabricated tower of the gantry tower crane for inspecting the cargo hold according to the preferred embodiment of the present invention.

FIG. 7 is a bottom exploded view showing the mobile platform of the gantry tower crane for inspecting the cargo hold according to the preferred embodiment of the present invention.

FIG. 8 is an exploded perspective view showing a state that a part of the prefabricated tower of the gantry tower crane for inspecting the cargo hold according to the preferred embodiment of the present invention is assembled.

FIG. 9 is an exploded perspective view showing a fixing unit of the gantry tower crane for inspecting the cargo hold according to the preferred embodiment of the present invention.

FIG. 10 is an exploded perspective view showing a tower unit of the gantry tower crane for inspecting the cargo hold according to the preferred embodiment of the present invention.

FIG. 11 is a perspective view showing a basket of the gantry tower crane for inspecting the cargo hold according to the preferred embodiment of the present invention.

FIG. 12 is a bottom perspective view showing the basket of the gantry tower crane for inspecting the cargo hold according to the preferred embodiment of the present invention.

FIG. 13 is a perspective view showing an overpass of the gantry tower crane for inspecting the cargo hold according to the preferred embodiment of the present invention.

FIG. 14 is a bottom perspective view showing the overpass of the gantry tower crane for inspecting the cargo hold according to the preferred embodiment of the present invention.

FIG. 15 is a schematic sectional view showing a state that the overpass of the gantry tower crane for inspecting the cargo hold according to the preferred embodiment of the present invention is folded.

FIG. 16 is a perspective view showing a state that a unit descending device of the gantry tower crane for inspecting the cargo hold according to the preferred embodiment of the present invention is installed in a gas dome.

FIG. 17 is a partially cut-away perspective view showing an installation state of the gantry tower crane for inspecting the cargo hold according to the preferred embodiment of the present invention.

FIG. 18 is a process diagram for explaining a method for installing a gantry tower crane for use in cargo hold inspection step by step according to the preferred embodiment of the present invention.

FIG. 19 is a process diagram including a protective cover installation step in the method for installing the gantry tower crane for use in the cargo hold inspection according to the preferred embodiment of the present invention.

FIG. 20 is a process diagram for explaining the protective cover installation step in the method for installing the gantry tower crane for use in the cargo hold inspection according to the preferred embodiment of the present invention.

FIG. 21 is a process diagram for explaining an installation rail installation step in the method for installing the gantry tower crane for use in the cargo hold inspection according to the preferred embodiment of the present invention.

FIG. 22 is a process diagram for explaining a mobile platform installation step in the method for installing the gantry tower crane for use in the cargo hold inspection according to the preferred embodiment of the present invention.

FIG. 23 is a process diagram for explaining a prefabricated tower installation step in the method for installing the gantry tower crane for use in the cargo hold inspection according to the preferred embodiment of the present invention.

FIG. 24 is a process diagram for explaining a basket installation step in the method for installing the gantry tower crane for use in the cargo hold inspection according to the preferred embodiment of the present invention.

FIG. 25 is a process diagram for explaining an overpass installation step in the method for installing the gantry tower crane for use in the cargo hold inspection according to the preferred embodiment of the present invention.

FIG. 26 is a process diagram for explaining the overpass installation step in the method for installing the gantry tower crane for use in the cargo hold inspection according to the preferred embodiment of the present invention.

### BEST MODE

### Mode for Invention

Hereinafter, a gantry tower crane for inspecting a cargo hold according to a preferred embodiment of the present invention will be described in detail with reference to the accompanying drawings.

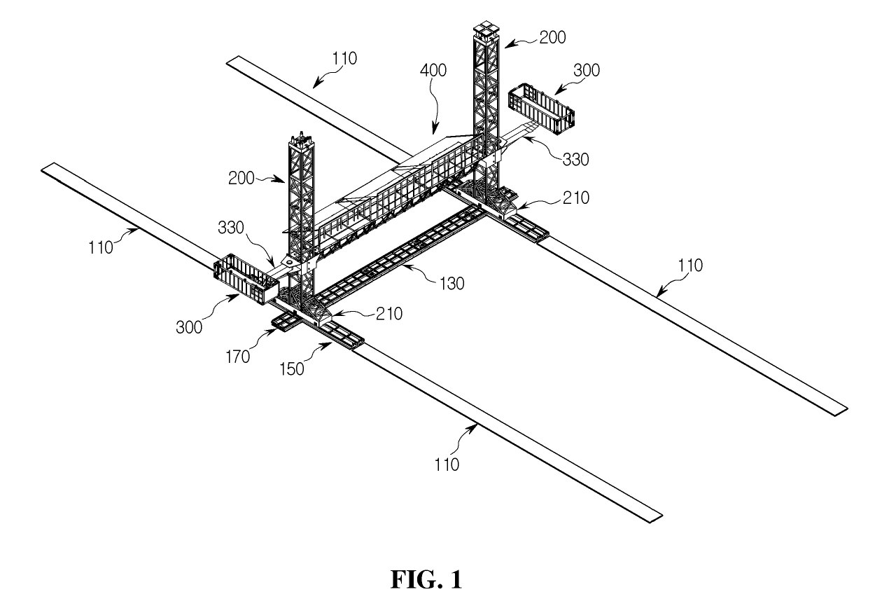

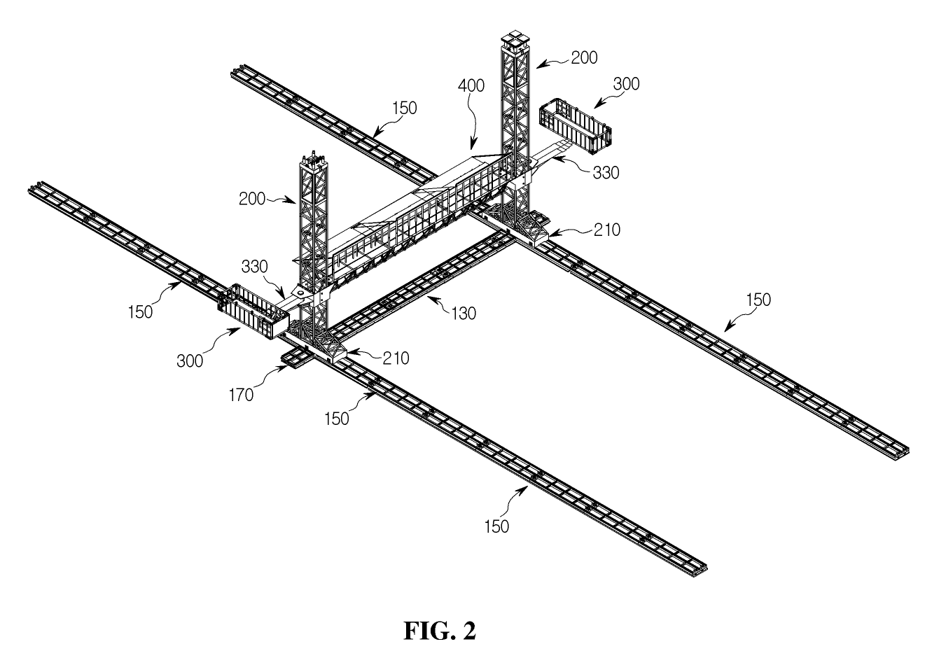

FIG. 1 is a perspective view showing a state before installing a running rail of a gantry tower crane for inspecting a cargo hold according to a preferred embodiment of the present invention, and FIG. 2 is a perspective view showing a state that the running rail of the gantry tower crane for inspecting the cargo hold according to the preferred embodiment of the present invention is installed.

According to the preferred embodiment of the present invention, the gantry tower crane for inspecting the cargo hold may include: two running rails 150 spaced apart from each other in a longitudinal direction of the cargo hold; two prefabricated towers 200 having mobile platforms 210, respectively, so as to be movable along the running rails 150; and a basket 300 movable up and down along the prefabricated tower 200, having a variable length with respect to a wall surface of the cargo hold 10 (see FIG. 16), and rotatable in a horizontal direction.

In addition, the gantry tower crane for inspecting the cargo hold of the present invention may further include an overpass 400 connected between the prefabricated towers 200 and serving as a path for an operator.

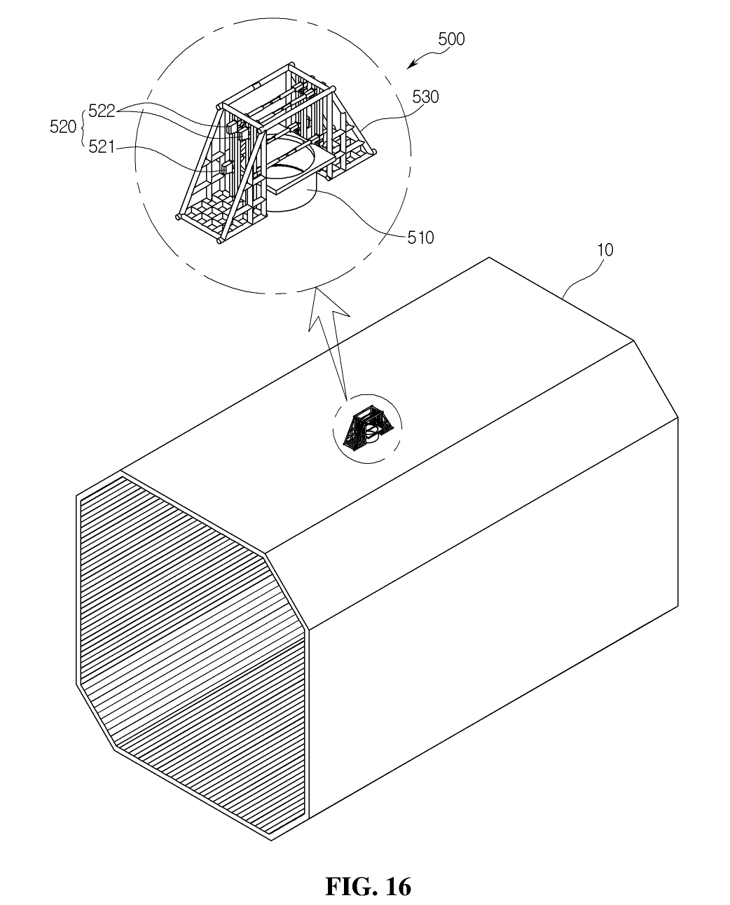

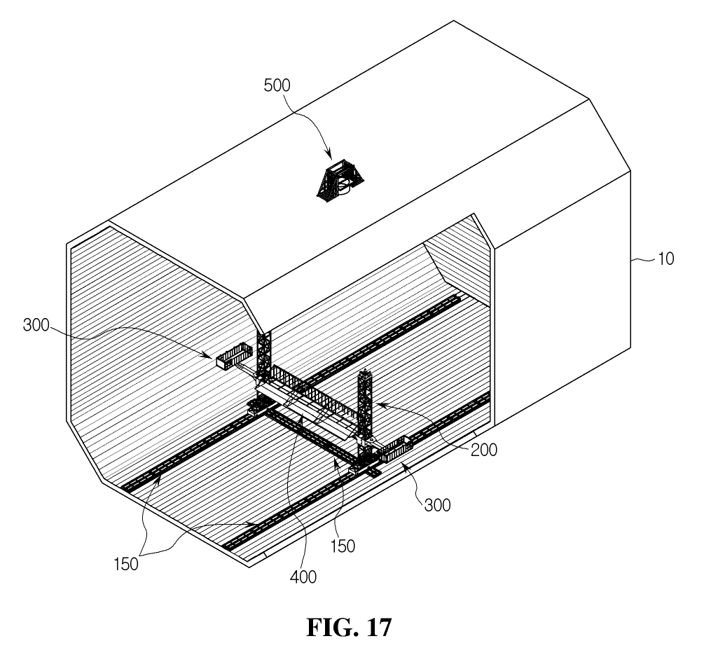

The gantry tower crane according to an embodiment of the present invention is provided with an installation rail 130 for installing the tower crane inside the cargo hold 10 (see FIG. 17) and a running rail 150 for guiding movement of the tower crane.

In addition, two running rails 150 are installed in the longitudinal direction of the cargo hold 10 to perform inspection along a wall surface of the cargo hold 10, and one prefabricated tower 200 may be installed on the two running rails 150, respectively.

In addition, the prefabricated tower 200 may be provided with the basket 300 that is moved up and down along the prefabricated tower 200 and freely rotated in the horizontal direction, and the overpass 400 allowing the operator to safely move (pass) is installed between the two prefabricated towers 200, so that the entire area of the cargo hold 10 may be inspected, the gantry tower crane required for inspecting the cargo hold 10 may be rapidly installed and dismantled, and the safety of operators is ensured.

Meanwhile, a rail 100 recited in the present invention may include the installation rail 130 and the running rail 150 as necessary. Although the two prefabricated towers 200 provided in one pair may be described as a first prefabricated tower and a second prefabricated tower for convenience of explanation, it should be understood that this description may be used in some cases to separate the two prefabricated towers as needed, and may refer to one or both of the two prefabricated towers as necessary.

In other words, in the present invention, two running rails 150 provided in one pair may be classified into a first running rail and a second running rail so as to be separated as necessary, and the two prefabricated towers 200 provided in one pair may be classified into a first prefabricated tower and a second prefabricated tower so as to be separated as necessary.

In addition, two baskets 300 provided in one pair may be classified into a first basket and a second basket so as to be separated as necessary, and elements separated into first and second elements will not be described using separate reference numerals.

In addition, the ‘inspection’ recited in the present invention should be understood as collectively referring to checking, maintenance, and repair of the cargo hold 10.

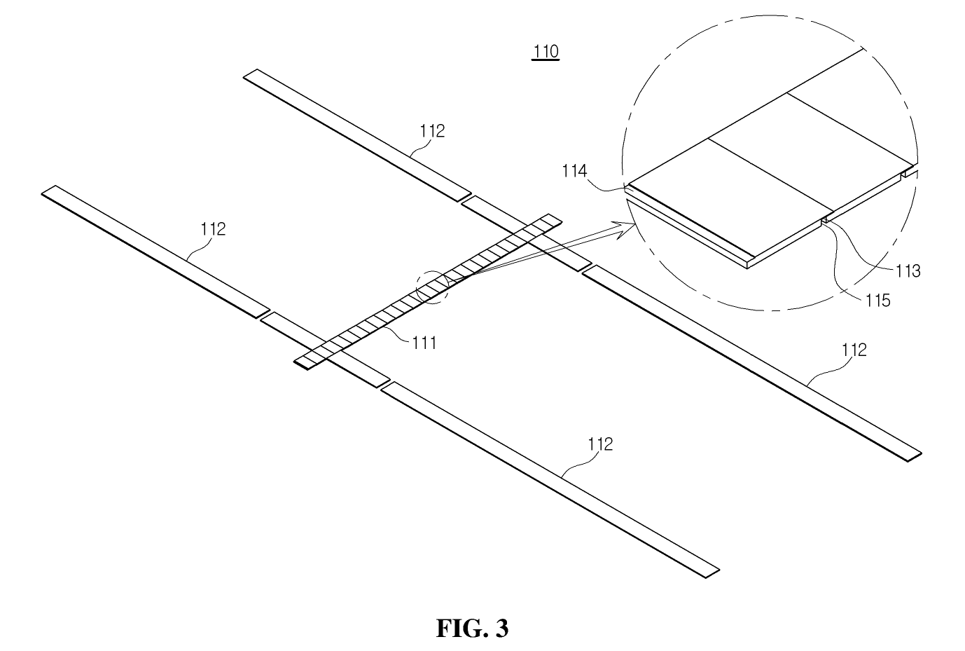

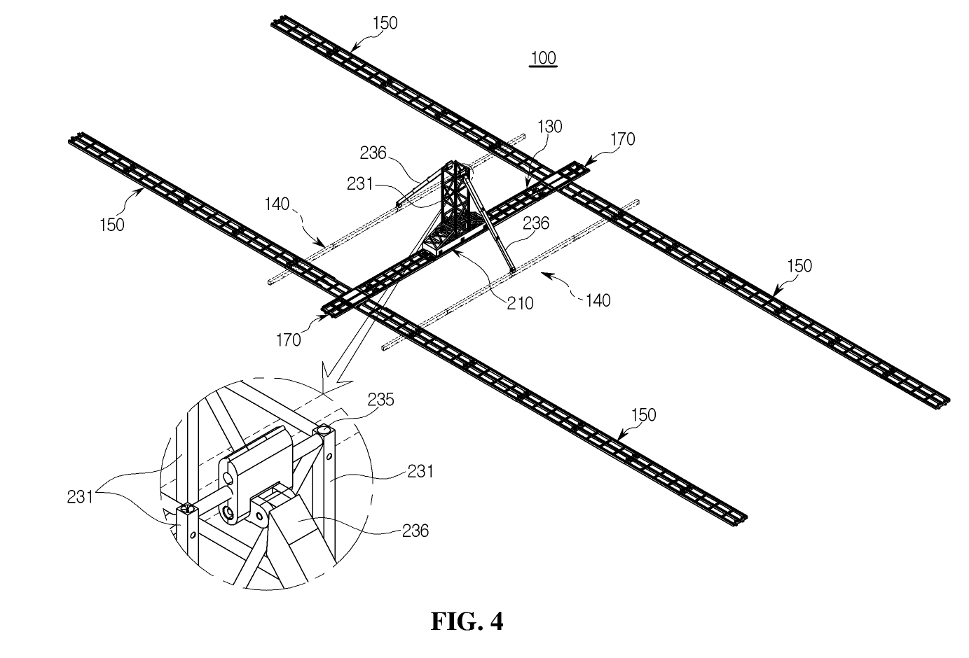

FIG. 3 is a perspective view showing a protective cover of the gantry tower crane for inspecting the cargo hold according to the preferred embodiment of the present invention, and FIG. 4 is a perspective view showing a state that a mobile platform is installed on a rail of the gantry tower crane for inspecting the cargo hold according to the preferred embodiment of the present invention.

As shown in FIGS. 1 to 4, the installation rail 130 for installing the prefabricated tower 200 and the running rail 150 for moving the prefabricated tower 200 are installed in the cargo hold 10.

The installation rail 130 and the running rail 150 may be installed on a floor surface of the cargo hold 10, and a protective cover 110 for preventing the floor surface of the cargo holds 10 from being damaged according to the installation of the rail 100 may be installed.

The protective cover 110 is formed of felt, rubber, fabric or the like, so that the rail 100 may not make direct contact with the floor surface of the cargo hold 10. The cargo hold 10 is formed of invar, which is excellent in corrosion resistance and extremely low in expansion coefficient, so that fine cracks, chips, or scratches may not occur.

In other words, the protective cover 110 may be formed of a material having resilience or elasticity to prevent the cargo hold 10 from being damaged by the load or impact applied during the installation of the rail 100 or during the movement of the prefabricated tower 200 along the rail 100.

The protective cover 110 may include a first protective cover 111 installed in the widthwise direction of the cargo hold 10 and a second protective cover 112 installed in the longitudinal direction of the cargo hold 10 at both ends of the first protective cover 111.

The first protective cover 111 may have a predetermined width and a predetermined length to prevent interference or obstruction of a tongue (not shown) protruding from the floor surface of the cargo hold 10.

One side of the first protective cover 111 may have a protruding portion 113 having a predetermined length so as to cover a top surface of the tongue, and the other side may have a coupling portion 114 so as to put on the protruding portion 113.

A groove 115 formed by the protruding portion 113 and the coupling portion 114 is located in the tongue protruding from the floor surface of the cargo hold 10 to prevent the tongue from being damaged or broken.

The second protective cover 112 may be provided in the form of a scroll so as to be installed in the longitudinal direction of the cargo hold 10, and may be formed at a lower end thereof with a groove portion 115 in the longitudinal direction so as to be fitted to the tongue.

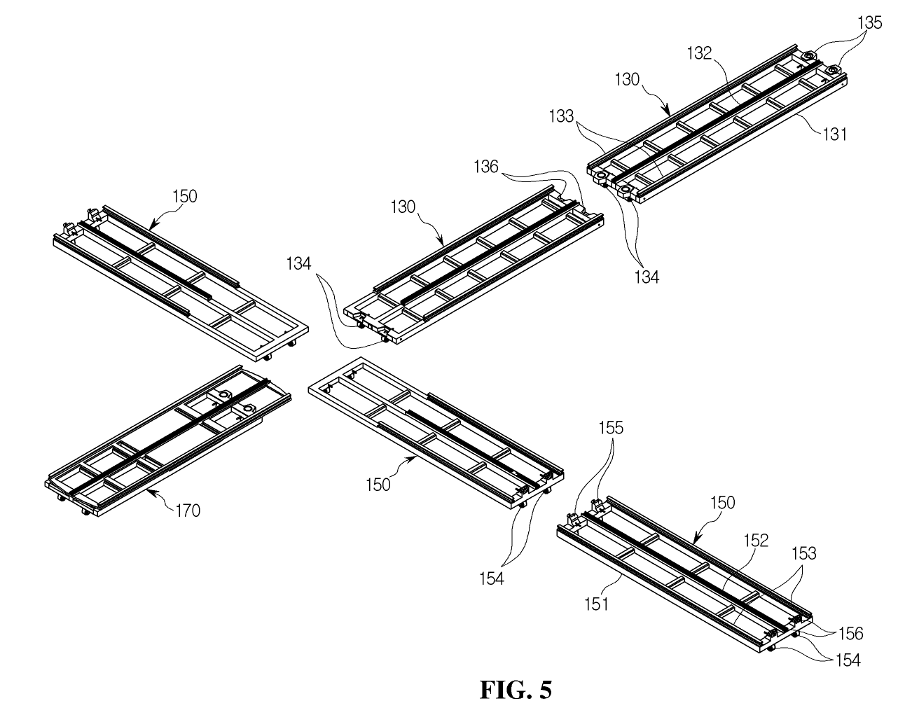

FIG. 5 is an exploded perspective view showing the rail of the gantry tower crane for inspecting the cargo hold according to the preferred embodiment of the present invention.

As shown in FIGS. 4 and 5, the rail 100 may include the installation rail 130 temporarily installed to install the prefabricated tower 200, and the running rail 150 allowing the prefabricated tower 200 to be movable in the longitudinal direction of the cargo hold 10.

The installation rail 130 may be arranged in the widthwise direction of the cargo hold 10 at a vertically lower portion of the gas dome formed on an upper surface of the cargo hold 10.

In addition, the installation rail 130 may include: a rail body 131 having a rectangular shape which has a predetermined length and a predetermined width; a rack 132 mounted on an upper surface of the rail body 131 to allow the prefabricated tower 200 to move; a guide rail 133 mounted in a same direction as the rack 132 at a position spaced apart from the rack 132 by a predetermined distance; and a plurality of moving wheels 134 mounted on a bottom surface of the rail body 131 so as to be movable along a floor surface of the cargo hold 10.

A plurality of installation rails 130 may be provided in the widthwise direction of the cargo hold 10, and rail bodies 131 may have a first coupling portion 135 and a second coupling portion 136 so that the installation rails 130 may be coupled to each other.

The first coupling portion 135 may be provided on one side of the rail body 131 so as to be coupled with another adjacent rail body 131, and a second coupling portion 136 may be provided on the other side of the rail body 131 so as to be coupled with another adjacent rail body 131.

The first coupling portion 135 and the second coupling portion 136 may be coupled to each other in the form of a male and female coupling, and the first coupling portion 135 and the second coupling portion 136 may be installed or detachably coupled with each other by a pin (not shown) and the like.

In addition, the moving wheel 134 is used to install and dismantle the installation rail 130, and allows the installation rail 130 to be freely moved and installed in a state that the installation rail 130 is lowered on the cargo hold 10 before the prefabricated tower 200 is installed.

In other words, the moving wheel 134 may include a damping wheel which may restrain the movement of the moving wheel 134 according to the load of the rail body 131 or the weight (load) of the prefabricated tower 200.

Such a damping wheel may freely move by the elastic force of a spring (not shown) when no load or weight is applied, and the elastic force of the spring is restrained when a load or weight is applied, so that the movement may be restrained as a brake (not shown) performs braking.

Such a damping wheel or gas spring may be any typical damping wheel or gas spring.

In addition, the installation rail 130 may include an auxiliary installation rail 140 to move the prefabricated tower 200 more safely.

The auxiliary installation rail 140 may have the same length as that of the rail body 131, and may be provided at both ends thereof with a wheel (not shown) to facilitate the movement.

The auxiliary installation rail 140 may be installed at a position spaced apart from both sides of the rail body 131 by a predetermined distance, and the auxiliary installation rail 140 further supports the prefabricated tower 200 through an outrigger 236 when the prefabricated tower 200 moves on the installation rail 130, so that the prefabricated tower 200, which moves vertically, may be stably moved.

A groove (not shown) that may be fitted around the tongue (not shown) may be formed in the auxiliary installation rail 140, and the tongue is pressed by fitting a fixing pin (not shown) at a position adjacent to the groove, so that the auxiliary installation rail 140 may be firmly fixed to the tongue.

In addition, the running rail 150 may include: a rail body 151 having a predetermined length and a predetermined width; a rack 152 mounted on an upper surface of the rail body 151 to allow the prefabricated tower 200 to move; a guide rail 153 mounted in a same direction as the rack 152 at a position spaced apart from the rack 152 by a predetermined distance; and a plurality of moving wheels 154 mounted on a bottom surface of the rail body 151 so as to be movable along a floor surface of the cargo hold 10.

The rail body 151 of the running rail 150 may have a first coupling portion 155 and a second coupling portion 156 at both ends of the rail body 151, respectively. The first coupling portion 155 and the second coupling portion 156 may be rotatably hinge-coupled to each other.

The running rail 150 as described above may be lowered together with the prefabricated tower 200 while being coupled to both side surfaces of the prefabricated tower 200, separated from the prefabricated tower 200, and spread and installed in the longitudinal direction of the cargo hold 10.

In addition, the rail 100 may include a rotation rail 170 which may rotate the prefabricated tower 200.

The rotation rail 170 has the same configuration as the installation rail 130 and the running rail 150, and has both ends formed in an arc shape, so that the rotation rail 170 may be rotated together with the prefabricated tower and may be coupled to other rails 130 and 150.

In other words, the installation rail body 131 and the running rail body 151 provided adjacent to the rotation rail 170 may be formed in the same arc shape as the arc of the rotation rail 170 so as to be coupled by the rotation of the rotary rail 170.

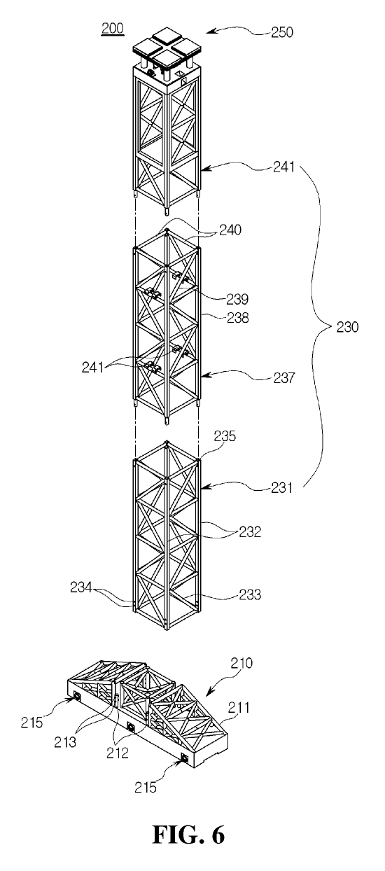

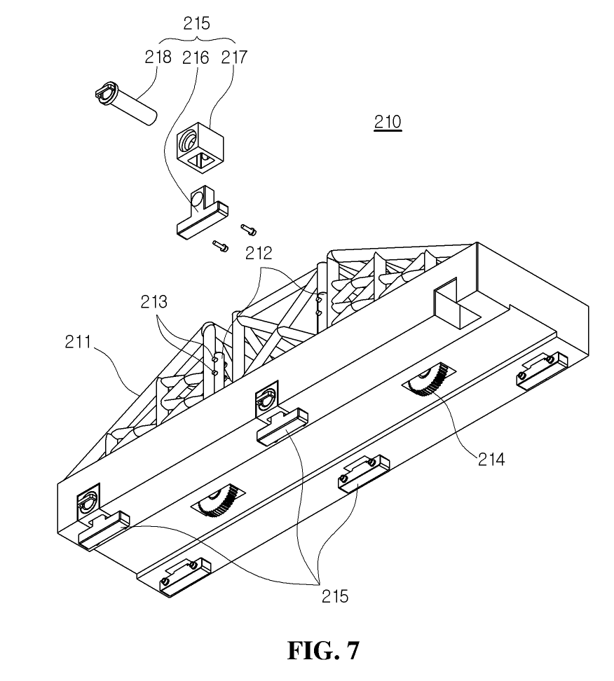

FIG. 6 is an exploded perspective view showing a prefabricated tower of the gantry tower crane for inspecting the cargo hold according to the preferred embodiment of the present invention, and FIG. 7 is a bottom exploded view showing the mobile platform of the gantry tower crane for inspecting the cargo hold according to the preferred embodiment of the present invention.

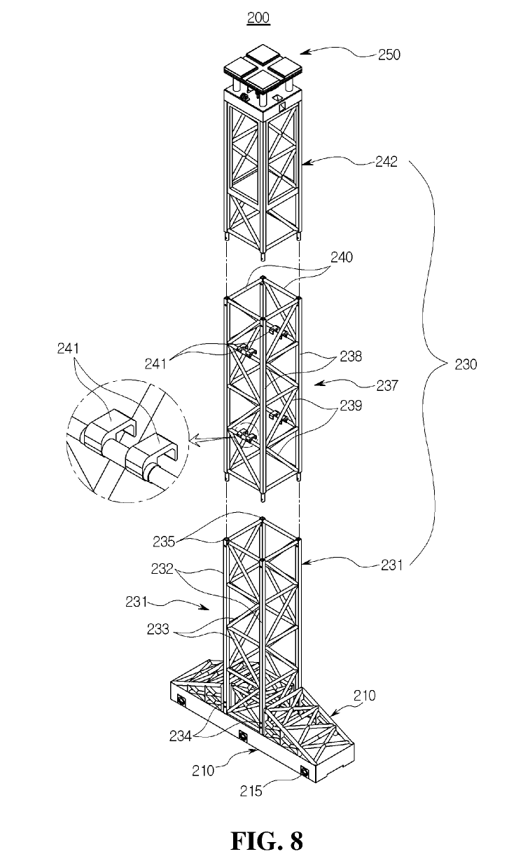

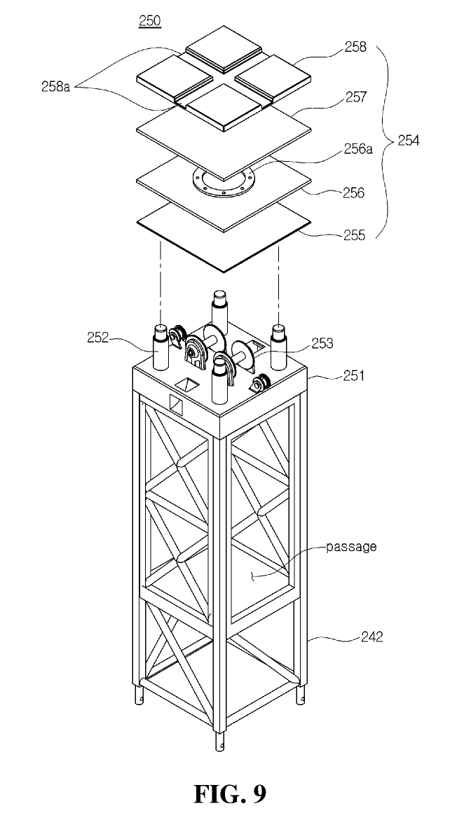

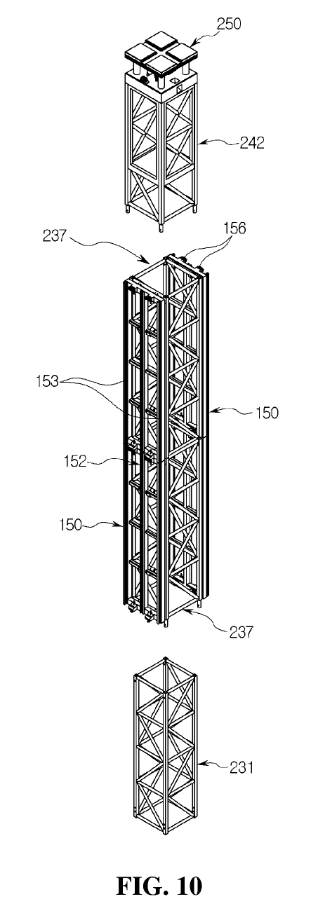

FIG. 8 is an exploded perspective view showing a state that a part of the prefabricated tower of the gantry tower crane for inspecting the cargo hold according to the preferred embodiment of the present invention is assembled, FIG. 9 is an exploded perspective view showing a fixing unit of the gantry tower crane for inspecting the cargo hold according to the preferred embodiment of the present invention, and FIG. 10 is an exploded perspective view showing a tower unit of the gantry tower crane for inspecting the cargo hold according to the preferred embodiment of the present invention.

As shown in FIGS. 6 to 10, the prefabricated tower 200 is movable in the longitudinal direction of the cargo hold 10, and the assembling of the basket 330 to the prefabricated tower 200 is completed in a state that the installation rail 130 is installed. Next, the prefabricated tower 200 is moved along the running rail 150 after changing the direction by the rotation rail 170.

In other words, the prefabricated tower 200 may change the direction thereof from the installation rail 130 to the running rail 150 by the rotation rail 170.

The prefabricated tower 200 may include: a mobile platform 210 movably mounted along the running rail 150; a plurality of tower units 230 vertically coupled to the mobile platform 210; and a fixing unit 250 making close contact with an upper surface of the cargo hold 10 to stably mount the tower unit 230.

The prefabricated towers 200 are moved along the running rails 150, and may be installed on a pair traveling rails 150, respectively. This allows inspecting the cargo hold 10 on both sides of the cargo hold 10 by using two prefabricated towers 200, and inspecting all front and rear wall surfaces of the cargo hold 10 by installing the overpass 400 between the two prefabricated towers 200.

The mobile platform 210 for moving the tower unit 230 along the running rail 150 may include: a platform body 211 having a predetermined size; a plurality of posts 212 vertically fixed to an upper portion of the platform body 211 such that the posts 212 are coupled with the tower unit 230; a plurality of pinion gears 214 mounted on a bottom surface of the platform body 211 such that the pinion gears 214 are movable along the running rail 150; and a guide roller 215 guided by the running rail 150 by making close contact with a side surface of the running rail 150 such that the prefabricated tower 200 is safely moved.

In addition, the mobile platform 210 may include a plurality of holes 213 formed in the post at predetermined intervals such that the mobile platform 210 is rapidly coupled with the tower unit 230, and a pin (not shown) fitted into the hole.

The mobile platform 210 has a platform body 211 having a predetermined size, and a plurality of posts 212 may be fixed to the platform body 211 to fix the tower unit 230.

The post 212 may have a plurality of holes 213 for firmly fixing the tower unit 230, and the post 212 may be provided with a fixing pin (not shown) which is fixedly fitted to the hole 213 and the tower unit 230.

The mobile platform 210 is movable along the running rail 150, and a pinion gear 214 that engages with the rack 132 of the installation rail 130 and the rack 152 of the running rail 150 may be rotatably mounted on a bottom surface of the mobile platform 210.

In addition, the guide roller 215 may be installed to allow the stable movement along the rails 130 and 150, and guide rollers 215 may be installed on both side surfaces of the mobile platform 210. In other words, the guide roller 215 is moved while making close contact with the guide rails 133 and 153 of the rails 130 and 150, thereby moving the prefabricated tower 200 more stably.

A plurality of guide rollers 215 are installed on both side surfaces of the mobile platform 210, and grooves having a predetermined size may be formed in both side surfaces of the platform body 211.

The guide member 216, which makes close contact with the guide rails 133 and 153, is substantially shaped as reversed ‘T’, and a movable member 217 for moving a position of the guide member 216 may be coupled to an upper portion of the guide member 216. The movable body 217 is fitted to the groove of the platform body 211, and an adjustment bolt 218 for moving the guide member 216 may be fastened to the movable body 217.

The tower unit 230 may include: a lower truss unit 231 coupled to the mobile platform 210; a plurality of middle truss units 237 coupled to an upper portion of the lower truss unit 231; and an upper truss unit 242 coupled to an uppermost end of the middle truss unit and serving as a path for an operator.

The tower unit 230 is vertically constructed from the floor surface to the ceiling of the cargo hold 10, and includes a lower truss unit 231 fixed to the mobile platform 210, a plurality of middle truss units 237 having the same shape and structure as the lower truss unit 231, and an upper truss unit 242 fixed to the uppermost end of the tower unit 230. The tower unit 230 may further include a fixing unit 250 fixed to an upper surface of the upper truss unit 242 so as to allow the prefabricated tower 200 to make close contact with the ceiling of the cargo hold 10 and to stably maintain the contact state.

The tower unit 230 may refer to one in which the lower truss unit 231, the middle truss unit 237, and the upper truss unit 242 are integrated, and may refer to one that further includes the fixing unit 250. In other words, the tower unit 230 may refer to the prefabricated tower 200 except for the mobile platform 210.

The truss units 231, 237, and 242 may have a rectangular parallelepiped shape having a predetermined height, a plurality of vertical frames 232 having a predetermined length are arranged in a rectangular shape in the lower truss unit 231, and cross frames 233 crossing each other are fixed between the vertical frames 232.

In addition, the vertical frame 232 of the lower truss unit 231 may have a hole 234 corresponding to the post 212 and the hole 213 of the platform body 211, and the post 212 and the vertical frame 232 may be firmly fixed by the fixing pin (not shown) passing through the holes 213 and 234 in a state that the post 212 and the vertical frame 232 are fitted to each other.

In addition, a coupling hole 235 may be formed at an upper end of the vertical frame 232, so that the middle truss unit 237 may be coupled to the vertical frame 232.

An outrigger 236 (see FIG. 4) for maintaining the prefabricated tower 200 in a stable state by moving along the auxiliary installation rail 140 when the prefabricated tower 200 is moved is rotatably installed in the lower truss unit 231.

The outrigger 236 may be installed at an angle of approximately 45° from the lower truss unit 231 so as to stably support the prefabricated tower 200. The support angle of the outrigger 236 may be varied as necessary.

As shown in FIGS. 4 and 6, the outrigger 236 has a variable length in a telescopic manner so as to support the prefabricated tower 200 on both sides of the prefabricated tower 200, so that fall down, rollover, and the like may be prevented when the prefabricated tower 200 moves along the installation rail 130.

One end of the outrigger 236 may be rotatably coupled to an upper end of the lower truss unit 231, and the other end of the outrigger 236 may be movably coupled to the auxiliary installation rail 140.

In addition, the middle truss unit 237 may include: a plurality of vertical frames 238 having a predetermined length and configured in a rectangular shape; cross frames 239 fixed between the vertical frames 238 such that the cross frames 239 cross the vertical frames 238 at different directions; a horizontal frame 240 fixed to an end of the cross frame 239; and a rotation bar 241 rotatably and elastically mounted on the horizontal frame 240.

The vertical frame 238 is provided at a lower portion thereof with a protrusion portion that is fitted to the vertical frame of other middle truss unit located under the middle truss unit 237, and formed at an upper portion thereof with a groove portion into which the protrusion portion of the vertical frame of another middle truss unit 237 located over the middle truss unit 237 is fitted.

In addition, the horizontal frame 240 may be fixed to the vertical frame 238 of the middle truss unit 237 between the cross frames 239, and the horizontal frame 240 may be provided with the rotation bar 241 for temporarily hooking the running rail 150.

Accordingly, the truss units 231 and 237 may be inserted into the cargo hold 10 to assemble the tower unit 230 of the prefabricated tower 200 while simultaneously inserting the running rail 150 together, so that the time required for installing the gantry tower crane for inspecting the cargo hold can be remarkably shortened.

The rotation bar 241 has a hook shape, and may be elastically installed so as to be rotatable by a torsion spring (not shown) and the like installed therein.

This allows the running rail 150 to be temporarily hooked to an outer surface of the middle truss unit 237, and the rotation bar 241 is rotated as the running rail 150 is lifted up to a predetermined height so that the running rail 150 may be separated from the middle truss unit 237.

The upper truss unit 242 has the same structure and shape as the truss units 231 and 237, and the upper truss unit 242 may be provided with a passage (see FIG. 9) through which the operator may pass.

When the rotation railing 351 is unfolded in a state that the basket 300, which is to be described as follows, is installed on the upper truss unit 242, a passage may be formed in a partial space of the upper truss unit 242 so that it is possible to pass through the overpass 400 installed between the prefabricated towers 200.

In addition, the fixing unit 250 may be provided at the upper end of the prefabricated tower 200 so as to stably fix the prefabricated tower 200 by making close contact with the ceiling of the cargo hold 10. The fixing unit 250 may press the prefabricated tower 200 against the ceiling of the cargo hold 10 to stably fix the prefabricated tower 200.

The fixing unit 250 may include: a fixing plate 251 provided at a same size as the tower unit 230; a plurality of cylinders 252 mounted on an upper surface of the fixing plate 251; a winch 253 mounted on the upper surface of the fixing plate 251; and a rotation plate 254 rotatably mounted on an upper surface of the cylinder 252.

The rotation plate 254 may include: a first plate 255 fixed to the upper surface of the cylinder 252; a second plate 256 rotatably coupled with a flat bearing 256a on an upper surface of the first plate 255; a third plate 257 mounted on an upper surface of the second plate 256 and formed therein with a groove (not shown) to which the flat bearing 256a is fitted; and a fourth plate 258 mounted on an upper surface of the third plate 257 and formed therein with a tongue insertion portion 258a to which a tongue of the cargo hold is fitted.

The upper truss unit 242 is provided at the upper surface thereof with the fixing unit 250, and the upper truss unit 242 is provided at the upper surface thereof with the fixing plate 251 having a predetermined thickness so as to stably fix the fixing unit 250.

A plurality of cylinders 252 may be provided on the upper surface of the fixing plate 251 so as to be pressed against the ceiling of the cargo hold 10, and the fixing plate 251 may be provided at the upper surface thereof with a winch 253 for moving up and down the basket 300.

Two winches 253 may be provided so that the basket 300 may be stably moved up and down, and a pulley for guiding the movement of a cable (not shown) of the winch 253 may be provided.

In addition, the rotation plate 254 in which a plurality of plates stacked may be provided on the upper surface of the cylinder 252, and when the prefabricated tower 200 changes the direction thereof from the installation rail 130 to the running rail 150 through the rotation rail 170, the rotation plate 254 is pressed against the ceiling of the cargo hold 10, which allows the prefabricated tower 200 to rotate in a stable posture.

In other words, since the prefabricated tower 200 is vertically installed from the floor surface to the ceiling of the cargo hold 10, the prefabricated tower 200 may be moved in a very unstable state when the mobile platform 210 is moved.

Therefore, in order to allow the prefabricated tower 200 to rotate in a more stable posture, the rotation plate 254 of the fixing unit 250 installed on the upper surface of the upper truss unit 242 may be pressed against the ceiling of the cargo hold 10.

Accordingly, the prefabricated tower 200 is rotated while maintaining a more stable posture in a state that the rotation plate 254 is pressed against the ceiling.

In addition, when the inside of the cargo hold 10 is inspected, the fixing unit 250 installed on the upper surface of the upper truss unit 242 maintains the rotation plate 254 being pressed against the ceiling of the cargo hold 10, so that the safety of the operator and the stable behavior of the basket 300 can be ensured.

The rotation plate 254 of the fixing unit 250 may be provided with the first plate 255 on the upper surface of the cylinder 252, the second plate 256 provided with the flat bearing 256a may be mounted on the upper surface of the first plate 255, and the third plate 257 formed in the bottom surface thereof with a groove so as to be coupled to the flat bearing 256a may be rotatably coupled to the upper surface of the second plate 256.

In addition, the fourth plate 258 having a predetermined thickness may be provided on the upper surface of the third plate 257, and the tongue insertion portion 258a in which the tongue protruding from the ceiling is fitted may be formed in the upper surface of the fourth plate 258.

The tongue insertion portion 258a may be substantially shaped as a cross, so that the rotation plate 254 may be coupled to the tongue regardless of the direction in which the prefabricated tower 200 is installed.

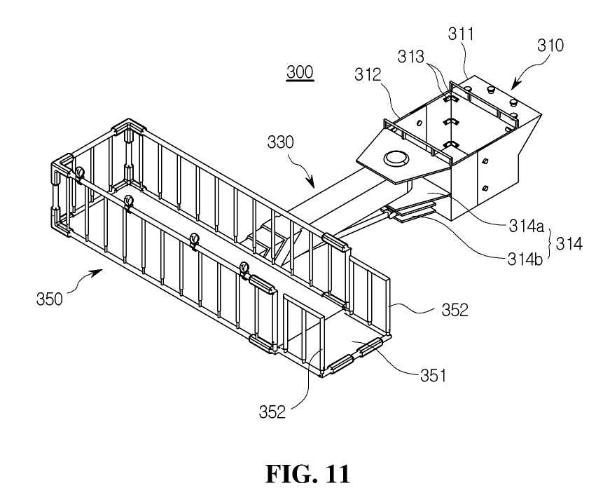

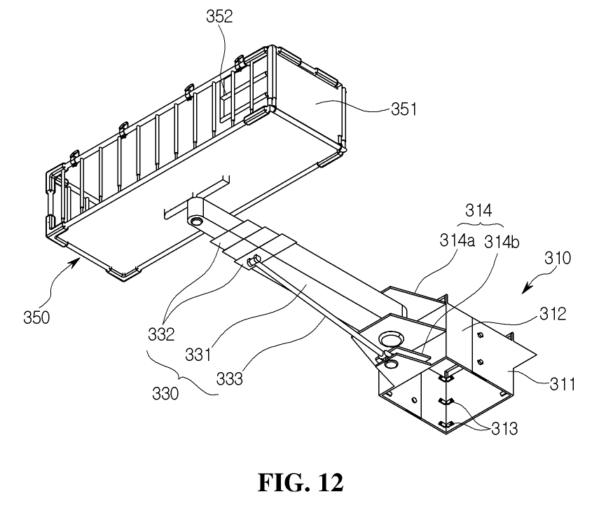

FIG. 11 is a perspective view showing a basket of the gantry tower crane for inspecting the cargo hold according to the preferred embodiment of the present invention, and FIG. 12 is a bottom perspective view showing the basket of the gantry tower crane for inspecting the cargo hold according to the preferred embodiment of the present invention.

As shown in FIGS. 11 and 12, the basket 300 of the gantry tower crane for inspecting the cargo hold according to the embodiment of the present invention is horizontally moved and rotated toward the wall surface of the cargo hold 10, so that the operator can inspect the entire area of the cargo hold 10.

To this end, the basket may include: an up-down movement frame 310 mounted on an outer surface of the prefabricated tower 200 so as to be movable up and down; a boom support 330 rotatably mounted on one surface of the up-down movement frame 310 and having a variable length; and a work table 350 rotatably mounted at an end of the boom support 330.

The up-down movement frame 310 may include: a first frame 311 provided with a wheel 313 so as to be movable along one surface of the prefabricated tower 200; a second frame 312 coupled to one side of the first frame 311 and provided with a wheel 313 so as to be movable along the other surface of the prefabricated tower 200; and a support frame 314 protruding such that the boom support 330 is rotatably mounted on one side of the second frame 312.

The up-down movement frame 310 is moved up and down by the winch 253 installed on the upper portion of the prefabricated tower 200, and the up-down movement frame 310 may include a first frame 311 coupled to one side of the prefabricated tower 200, and a second frame 312 coupled to the other side of the first frame 311.

A plurality of wheels 313 that rotate along the vertical frames 232 and 238 of the prefabricated tower 200 may be installed in an inner surface of the up-down movement frame 310, and the first frame 311 and the second frame 312, which configure the up-down movement frame 310, may be fixed to each other with a bolt or a pin in a state of making close contact with the outer surface of the prefabricated tower 200.

In addition, the support frame 314 may be fixed to the up-down movement frame 310 so as to install the boom support 330, and the support frame 314 may include a first support frame 314a on which the boom support 330 is installed and a second support frame 314b on which an auxiliary frame is installed.

The boom support may include: a rotation boom support 331 rotatably coupled to one side of the up-down movement frame 310; a plurality of movable boom supports 332 movable in the rotation boom support 331 in a telescopic manner; and a support bar 333 rotatably mounted on one side of the up-down movement frame 310 and the rotation boom support 331 so as to stably support the rotation boom support 332.

In addition, the work table 350 may include: a rotation railing 351 rotatable about one side of the work table 350 so as to communicate with the prefabricated tower 200; and an auxiliary railing 352 rotated together with the rotation railing 351, provided on both sides of the rotation railing 351, and having a predetermined height.

The boom support 330 has a variable length so that the operator may move toward the wall surface of the cargo hold 10, and may be coupled to horizontally rotate about the support frame 314 of the up-down movement frame 310.

One side of the rotation boom support 331 may be rotatably coupled to the up-down movement frame 310, and the other side of the rotation boom support 331 may be coupled to a plurality of movable boom supports 332 such that the length is varied in a telescopic manner.

In other words, the rotation boom support 331 horizontally rotates the work table 350 in a desired direction about the up-down movement frame 310, and the movable boom support 332 moves the work table 350 to a desired position (distance) so that the operator may be moved to the desired position.

In addition, the support bar 333 may be installed on a bottom surface of the rotation boom support 331 and the support frame 314 of the up-down movement frame 310 so as to support the rotation boom support 331 more stably.

In addition, the work table 350 on which the operator can ride may be coupled to the end of the boom support 330, the work table 350 may be provided with a railing along the periphery of the support plate, and the rotation railing 351 communicating with the passage of the upper truss unit 341 may be installed on one surface of the railing of the work table 350.

In other words, the rotation railing 351 allows one side of the railing to be opened and closed as necessary, and the rotation railing 351 may be provided with auxiliary railings 352 serving as railings on both left and right sides of the rotation railing 351 when the rotation railing 351 is unfolded.

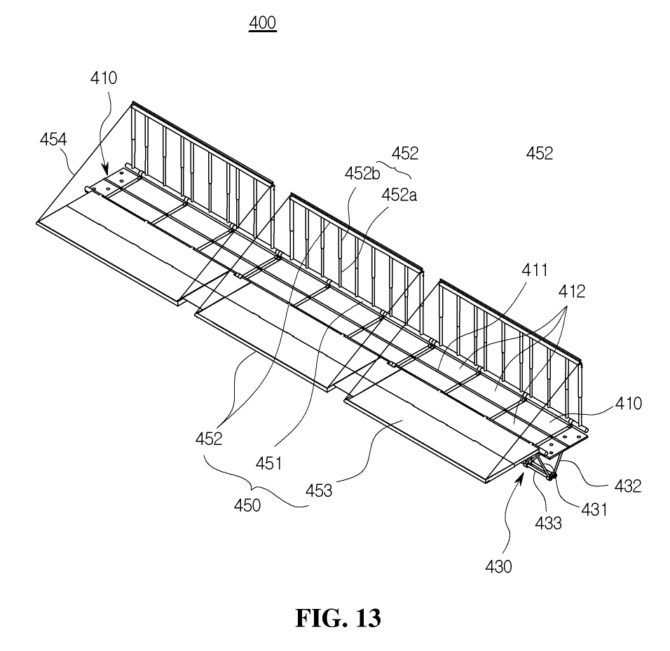

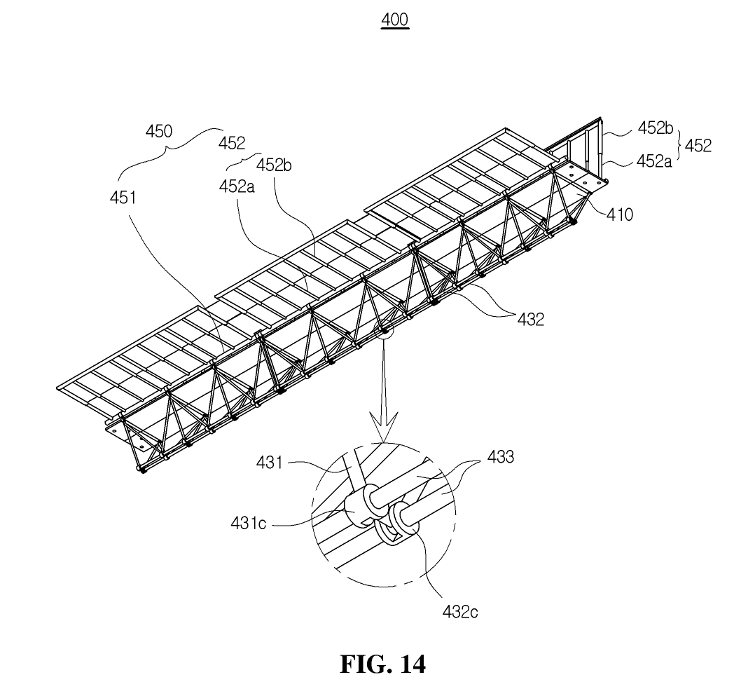

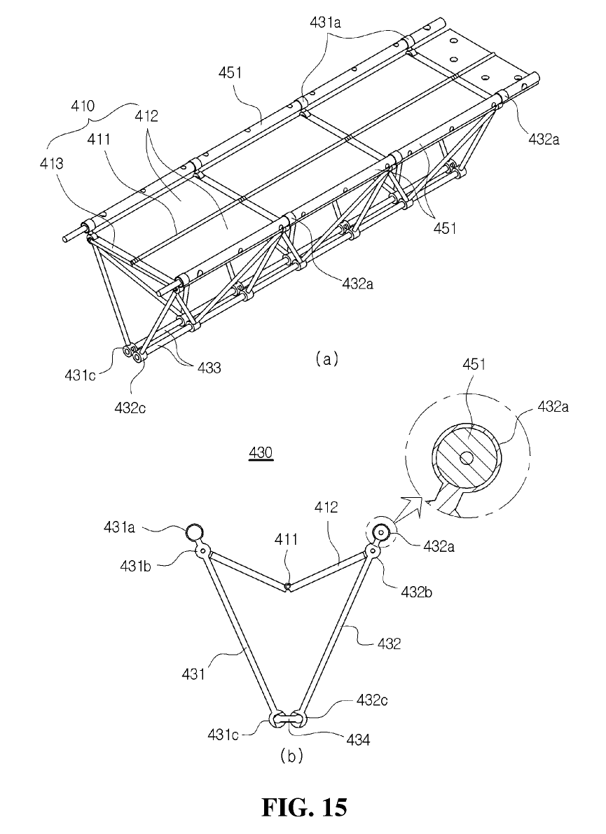

FIG. 13 is a perspective view showing an overpass of the gantry tower crane for inspecting the cargo hold according to the preferred embodiment of the present invention, FIG. 14 is a bottom perspective view showing the overpass of the gantry tower crane for inspecting the cargo hold according to the preferred embodiment of the present invention, and FIG. 15 is a schematic sectional view showing a state that the overpass of the gantry tower crane for inspecting the cargo hold according to the preferred embodiment of the present invention is folded.

As shown in FIGS. 1, 2 and 13 to 15, the overpass 400 may be installed between a pair of prefabricated towers 200 and may be used as a passage through which the operator can pass or a work space. In other words, the overpass 400 may be selectively used as a work passage or the work space of the operator as necessary, and the overpass 400 may be used as the work space as the auxiliary foothold 450 is deployed.

The overpass 400 may include: a foothold 410 serving as a path or a work space for an operator; a foothold support 430 having a truss structure to stably support the foothold 410; and an auxiliary foothold 450 rotatable toward an outside such that the work space extends on one side of the foothold 410.

The foothold 410 may include: a foothold body 412 rotatable about a hinge 411; and a rotation link 413 provided at predetermined intervals on both sides of the foothold body 412.

Each of the first and second frames 431 and 432 of the foothold support 430 may include: a first ring 431a and 432a provided at upper ends of the first and second frames 431 and 432 such that the railing frame 451 is rotatably coupled; a second ring 431b and 432b provided at a lower portion of the first ring 431a and 432a such that the rotation link 413 is rotatably coupled; and a third ring 431c and 432c to which the rotation rod 433 and the connection rod 434 are rotatably coupled.

The auxiliary foothold 450 may include: a railing frame 451 rotatably coupled to upper sides of the first and second frames 431 and 432; and two railings 452 detachably coupled to the railing frame 451.

The railing 452 may include: a first railing frame 452a having a predetermined length; and a second railing frame 452b movably coupled to an outer surface of the first railing frame 452a.

One of the two railings may further include a work foothold 453 provided to form the work space of the operator.

A chain 454 connected between the railings 452 such that the two railings are stably fixed to each other may be further included.

As shown in FIGS. 1 to 15, the overpass 400 may be installed between the two prefabricated towers 200. This overpass 400 allows passing from a first prefabricated tower to a second prefabricated tower, and securing the work space in which the operator may work by unfolding one of the two railings 452 to the outside of the foothold 410 as necessary.

The foothold 410 of the overpass 400 may have a predetermined width and a predetermined length, and the foothold 410 may have a structure that may be fitted to each other.

In addition, the foothold 410 may have a folding structure that the foothold 410 may be folded so as to be inserted through the gas dome of the cargo hold 10. In other words, the foothold 410 may have a foldable structure so as to be inserted into the cargo hold 10 through the gas dome (not shown).

The foothold 410 may be rotatable about the hinge 411 such that the foothold may be folded or unfolded, and the foothold body 412 having a predetermined length and a predetermined width may be coupled to both sides of the hinge 411.

In addition, the rotation link 413 rotatably coupled to the foothold support 430 while supporting the foothold body 412 may be fixed to both side surfaces of the foothold body 412. The rotation link 413 may be rotatably coupled to the second rings 431b and 432b of the foothold support 430 so as to fold the foothold body 412 as necessary while supporting the foothold body 412.

The foothold support 430 may include: a first frame 431 and a second frame 432 provided at left and right sides of the foothold support 430 at predetermined angles; two rotation rods 433 rotatably coupled to one ends of the first and second frames 431 and 432 in a longitudinal direction; and a connection rod 434 fixed between the two rotation rods 433.

The foothold support 430 may have a truss structure that is coupled to a bottom surface of the foothold 410 to firmly support the foothold 410, and may have a rotation structure that the foothold 410 may be folded as necessary.

The foothold support 430 may include the first frame 431 and the second frame 432, each of which having a truss structure. The first frame 431 and the second frame 432 may have the same shape.

As shown in FIG. 15, the first frame 431 and the second frame 432 have a predetermined height, and the first rings 431a and 432a may be provided at uppermost ends of the first and second frames 431 and 432, respectively.

In addition, the second rings 431b and 432b may be provided at lower portions of the first rings 431a and 432a so as to be rotatably coupled to the rotation link 413 of the foothold 410. In other words, the rotation link 413 of the foothold 410 may be rotated about the second rings 431b and 432b.

In addition, the first and second frames 431 and 432 may be coupled so as to be rotatable in a direction symmetrical to each other. In other words, as shown in FIG. 15b, the third rings 431c and 432c may be provided at lower ends of the first and second frames 431 and 432, respectively.

In addition, rotation rods 433 may be rotatably coupled to the third rings 431c and 432c in the longitudinal direction of the foothold 410, and the connection rod 434 passing through the third rings 431c and 432c may be provided between two rotation rods 433.

Each of the first frame 431 and the second frame 432 may be rotatably coupled about the rotation rod 433, and the foothold body 412 may be folded or unfolded by the rotation of the first frame 431 and the second frame 432.

The first rings 431a and 432a of the first frame 431 and the second frame 432 may be rotatably coupled with a railing frame 451 formed as a rod having a predetermined length. In other words, the railing frame 451 may be rotatably fitted to the inside of the first rings 431a and 432a.

The railing frame 451 may be coupled to the first frame 431 and the second frame 432, and the railing frame 451 may be fixed with the railing 452 having a predetermined height.

The railing 452 may be separated or coupled to the railing frame 451 by fitting. The railing 452 may have a structure which may vary the length of the railing 452 to secure a work space as necessary.

The railing 452 may include a first railing frame 452a having a predetermined length and a second railing frame 452b movably coupled to an outer surface of the first railing frame 452a.

The first railing 452a may be formed as a circular pipe having a predetermined length, and the second railing 452b may be movably coupled along the outer surface of the first railing 452a to vary the length of the railing 452 as necessary.

In addition, the railing 452 may further include a work foothold 453 to use the work foothold as a foothold for working. The foothold 453 may have a structure that may be unfolded or folded according to a variable length, such as the railing 452, or a structure in which the length is varied in a telescopic manner.

In addition, two railings 452 may be provided with the chain 454 to stably maintain a state that the railing 452 is unfolded so as to be used as a work foothold. The chain 454 may include a rope or a cable as well as an iron chain.

Hereinafter, the coupling relation of the gantry tower crane for inspecting the cargo hold according to the preferred embodiment of the present invention will be described in detail.

FIG. 16 is a perspective view showing a state that a unit descending device of the gantry tower crane for inspecting the cargo hold according to the preferred embodiment of the present invention is installed in a gas dome, and FIG. 17 is a partially cut-away perspective view showing an installation state of the gantry tower crane for inspecting the cargo hold according to the preferred embodiment of the present invention.

As shown in FIGS. 16 and 17, the gantry tower crane for inspecting the cargo hold according to an embodiment of the present invention may be provided with a unit descending device 500 which may insert the rail 100, the prefabricated tower 200, the basket 300, and the overpass 400, which are separated from each other, through the gas dome (not shown) formed in the cargo hold 10 and into the cargo hold 10.

The unit descending device 500 may include a fixing frame 530 having a cylindrical body 510 coupled to an inner surface of the gas dome (not shown) and cylinders 520 that alternately move up and down on the outer surface of the cylindrical body 510.

The cylinders 520 may be installed in directions symmetrical to each other with respect to the cylindrical body 510, and the cylinders 520 may include a first cylinder 521 and a second cylinder 522 so as to be moved up and down alternately.

The unit descending device 500 is installed in the gas dome and inserts the rail 100, the prefabricated tower 200, the basket 300, and the overpass 400 into the cargo hold 10, and unit descending device 500 sequentially assembles the prefabricated tower 200.

In other words, the unit descending device 500 descends the lower truss unit 231 and a plurality of middle truss units 237 while sequentially assembling (coupling) the lower truss unit 231 and a plurality of middle truss units 237.

The prefabricated tower 200 mounts the lower truss unit 231 on the first cylinder 521 of the unit descending device 500, and a first middle truss unit 237 is coupled to the upper surface of the lower truss unit 231.

Accordingly, the first middle truss unit 237 is lowered by the first cylinder 521, and the lowered first middle truss unit 237 is lowered after the first middle truss unit 236 is coupled in a state of being mounted on the second cylinder 522.

In other words, the middle truss unit 237 is lowered by the reciprocation of the first cylinder 521 and the second cylinder 522. At this time, the descending height of the first cylinder 521 and the second cylinder 522 is shorter than the height of the middle truss unit 237, so that the first cylinder 521 and the second cylinder 522 lowers the first middle truss unit 237 to the upper surface of the gas dome by the reciprocation.

The second middle truss unit 237 is coupled to the upper surface of the lowered first middle truss unit 237, and a second middle truss unit 237 is descended to the upper surface of the gas dome by the reciprocation of the first cylinder 521 and the second cylinder 522, and then coupled with a third middle truss unit 237.

The middle truss units 237 are sequentially coupled to each other, the lower truss unit 231, the middle truss unit 237, and the upper truss unit 242, which configure the tower unit 230, are coupled to each other, and the fixing unit 250 is sequentially coupled and descended.

The tower units 230 including the lower truss unit 231, the middle truss unit 237, and the upper truss unit 242 may be firmly fixed by the coupling of the fixing pin (not shown) and the like.

In addition, the running rail 150 may be lowered in a state that the running rail 150 is coupled on both sides of the tower unit 230.

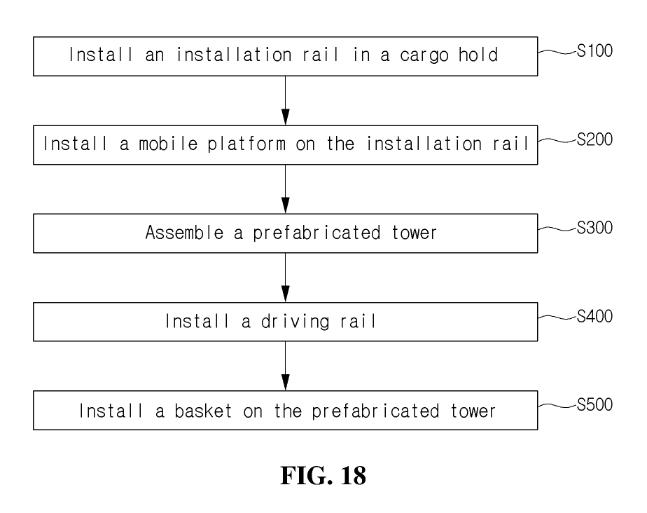

FIG. 18 is a process diagram for explaining a method for installing a gantry tower crane for use in cargo hold inspection step by step according to the preferred embodiment of the present invention.

As shown in FIGS. 1 to 18, a method for installing a gantry tower crane for use in cargo hold inspection according to an embodiment of the present invention may include: (a) a step S100 of installing an installation rail on a floor surface of a cargo hold in a widthwise direction; (b) a step S200 of movably installing a pair of mobile platforms, which are inserted into an interior of the cargo hold, on the installation rail; (c) a step S300 of assembling a pair of prefabricated towers by coupling tower units to each of the mobile platforms; (d) a step S400 of installing a running rail on both ends of the installation rail in a longitudinal direction of the cargo hold; and (e) a step S500 of installing a basket on each of the prefabricated towers such that the basket is movable up and down along the prefabricated tower.

Hereinafter, the method for installing the gantry tower crane for use in the cargo hold inspection according to the present invention will be described with reference to FIGS. 18 to 26, and the method will be described with reference to FIGS. 1 to 17.

FIG. 18 is a process diagram for explaining a method for installing a gantry tower crane for use in cargo hold inspection step by step according to the preferred embodiment of the present invention.

As shown in FIG. 18, in the method for installing the gantry tower crane according to an embodiment of the present invention, the installation rail 130 may be installed on the floor surface of the cargo hold 10 in the widthwise direction in step S100.

The installation rail 130 may be inserted (or lowered) through the gas dome formed in the ceiling of the cargo hold 10.

The gantry tower crane according to the present invention may be installed such that the gantry tower crane is inserted through the gas dome formed in the ceiling of the cargo hold 10. The gantry tower crane, which is disassembled after the completion of the inspection of the cargo hold 10, is discharged to the outside of the cargo hold 10 through the gas dome. Therefore, it should be understood that all of the gantry tower crane described below are inserted or discharged through the gas dome.

In step S200, the mobile platform 210 may be movably installed on the installation rail 130 installed on the floor surface of the cargo hold 10.

The mobile platform 210 may be mounted with the tower unit 230 formed with a plurality of middle truss units 237 so as to form a height ranging from the floor surface to the ceiling of the cargo hold 10, and the fixing unit 250 may be provided on the upper surface of the tower unit 230. In step S300, the mobile platform 210 may move the prefabricated tower 200 including the tower unit 230 and the fixing unit 250 as necessary.

The mobile platform 210 may move the prefabricated tower 200 from the installation rail 130 to the running rail 150, as well as along the running rail 150.

As the prefabricated tower 200 is installed, the mobile platform 210 moves to both ends of the installation rail 130. In step S400, the moved mobile platform 210 may be provided with the running rail 150 that is lowered in a state of being installed in the middle truss unit 237.

As shown in FIG. 10, the running rail 150 may be lowered in a state of being hooked by the rotation bar 241 of the middle truss unit 237. The running rail 150 is lifted by a predetermined height at the upper portion of the gas dome by using a crane (not shown) and the like.

The running rail 150 may be installed along the floor surface of the cargo hold 10 in the lengthwise direction of the cargo hold 10 as the running rail 150 is separated and descended from the rotation bar 241 of the middle truss unit 237.

The prefabricated tower 200 moved to the both ends of the installation rail 130 moves to a position of the gas dome again, so that the basket 300 may be mounted on the prefabricated tower 200.

In step S500, the basket 300 may be installed on the first prefabricated tower disposed on the installation rail 130, and on the second prefabricated tower.

The basket 300 has a work space having a predetermined size, so that the operator may inspect the cargo hold 10.

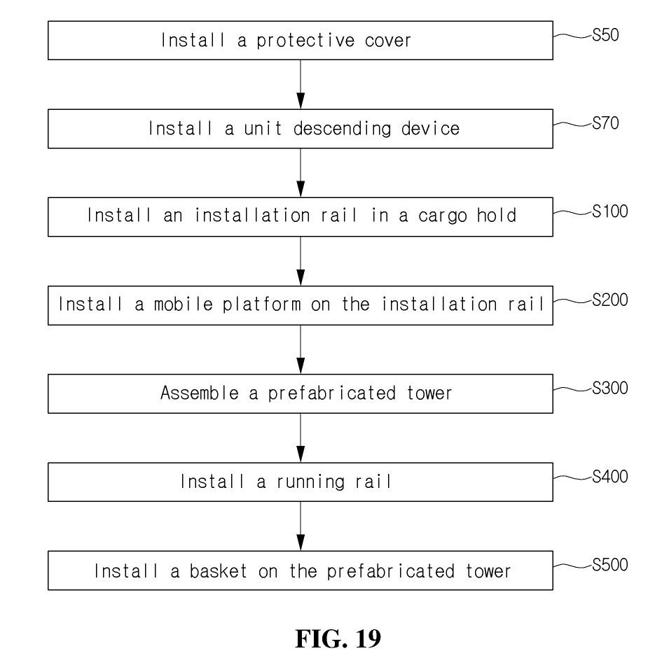

FIG. 19 is a process diagram including a protective cover installation step in the method for installing the gantry tower crane for use in the cargo hold inspection according to the preferred embodiment of the present invention.

As shown in FIG. 19, in step S50, the protective cover 110 for preventing the damage or breakage of the cargo hold 10 may be installed before the installation rail 130 is installed in the cargo hold 10.

In addition, in step S70, the unit descending device 500 capable of lowering the tower unit 230 and the fixing unit 250 while assembling the tower unit 230 and the fixing unit 250 may be installed in the gas dome (not shown) of the cargo hold 10.

The step of installing the protective cover 110 and the step of installing the unit descending device 500 may be performed before the installation rail 130 is installed.

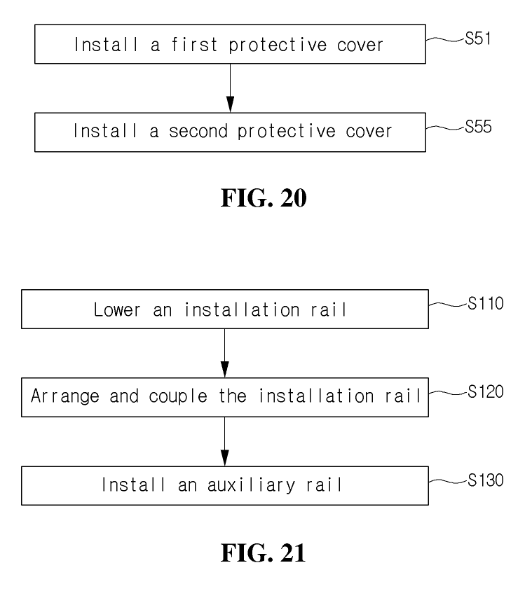

As shown in FIGS. 19 and 20, the protective cover installation step S50 may include: a step S51 of installing a first protective cover 111 in the widthwise direction of the cargo hold 10; and a step S55 of installing a second protective cover 112 in the longitudinal direction of the cargo hold 10 at both ends of the first protective cover 111.

The first protective cover 111 may have a plate shape having a predetermined size, a protruding portion 113 may be provided on one side of the first protective cover 111, and a coupling portion 114 corresponding to the protruding portion 113 may be formed on the other side of the first protective cover 111.

The protruding portion 113 and the coupling portion 114 of the first protective cover 111 are coupled to each other in the form of surrounding the outer surface of the tongue that protrudes from the floor surface of the cargo hold 10 so as to protect the tongue together with the floor surface.

In addition, the second protective cover 112 may be provided in the form of a scroll having a predetermined length, and the first protective cover 111 and the second protective cover 112 may be inserted (or lowered) into the cargo hold 10 by using the crane (not shown) provided on the upper side of the cargo hold 10.

In addition, the protective cover 110 is installed on the floor of the installation rail 130 and the running rail 150 to prevent the damage or breakage of the floor surface of the cargo hold 10, and may be formed of a material having elasticity such as felt, fabric, rubber, or a synthetic resin.

In addition, the protective cover 110 prevents the cargo hold 10 from being damaged or broken by preventing the prefabricated tower 200, the basket 300, the overpass 400, and the like from making direct contact with the cargo hold 10 when inserting (lowering) the prefabricated tower 200, the basket 300, the overpass 400, and the like, and prevents the damage or breakage of the cargo hold 10 due to falling of a tool and the like during the work of the operator.

As shown in FIG. 19, in the unit descending device installation step, the unit descending device 500 is moved to the upper surface of the gas dome of the cargo hold 10. In order to protect the inner surface of the gas dome through the descent of the unit descending device 500, the cylindrical body 510 of the unit descending device 500 is coupled to the inner surface of the gas dome, while the unit descending device 500 may be seated on the upper surface of the cargo hold 10.

The unit descending device 500 may insert (or lower) the rail 100, the prefabricated tower 200, the basket 300, and the overpass 400, which are separated from each other, into the cargo hold 10.

The unit descending device 500 may be provided on both side surfaces thereof with a first cylinder 521 and a second cylinder 522, which form one pair, and the unit descending device 500 may be provided at a center thereof with the cylindrical body 510, which is fitted to the inner surface of the gas dome to prevent the damage or breakage of the gas dome.

The unit descending device 500 may be moved to the position of the gas dome by the crane and the like, and the cylindrical body 510 may be coupled to the inner surface of the gas dome as the unit descending device 500 is lowered.

In addition, the unit descending device 500 may be seated in a stable state on the upper surface of the gas dome simultaneously with the coupling of the cylindrical body 510. In other words, as the unit descending device 500 is moved by the crane (not shown) and lowered from the upper side of the gas dome, the unit descending device 500 may be seated on the upper surface of the cargo hold 10 together with the coupling of the cylindrical body 510.

The installation rail 130 may be installed using the unit descending device 500 or the crane (not shown).

FIG. 21 is a process diagram for explaining an installation rail installation step in the method for installing the gantry tower crane for use in the cargo hold inspection according to the preferred embodiment of the present invention.

As shown in FIGS. 18, 19, and 21, in the installation step S100 of the installation rail 130, the installation rail 130 may be installed on the floor surface of the cargo hold 10 so that the prefabricated tower 200 vertically installed in the cargo hold 10 may be moved in a straight-line direction.

The installation step of the installation rail 130 may include: a step S110 of lowering the installation rail 130 inside the cargo hold 10; a step S120 of arranging installation rails 130 such that an installation rail 130 which is lowered beforehand and installation rails 130 which are sequentially lowered are disposed in a straight line, and sequentially coupling the installation rails 130 with each other; and a step S130 of separating the auxiliary installation rail 140 coupled to both side surfaces of the installation rail 130.

The auxiliary installation rail 140 may be firmly fixed so as not to move in the tongue of the cargo hold 10.

In step S110, the installation rail 130 may be lowered into the cargo hold 10 by the crane.

In step S120, a plurality of installation rails 130 may be sequentially inserted while being arranged in a row in the widthwise direction of the cargo hold 10, and coupled to each other such that adjacent rail bodies 131 are arranged in a straight line.

In the installation rails 130 arranged in a row, the first coupling portion 135 of the rail body 131 and the second coupling portion 136 of other rail body 131 disposed adjacent to the first coupling portion 135 of the rail body 131 are coupled to each other. At this time, the first coupling portion 135 and the second coupling portion 136 may be fixed by a fixing device such as the fixing pin (not shown).

In addition, in step S130, the auxiliary installation rail 140 may be separated and installed on both sides of the installation rail 130 in a state in which the installation rails 130 are completely installed.

The moving wheel 134 is installed on the bottom surface of the rail body 131 so as to be movable, and the installation rail 130 may be switched into a stopped state so that the rail body 131 is not moved by the self-weight of the rail body 130 as the rail bodies 131 are coupled.

In other words, as the rail bodies 131 are coupled, the total weight of the rail body 131 increases, so that the moving wheel 134 is restrain from moving due to the weight of the rail body 131.

In addition the auxiliary installation rail 140 separated from the rail body 131 is provided for more secure movement of the prefabricated tower 200, and the auxiliary installation rail 140 may be fixed to the tongue (not shown) of the cargo hold 10 by a plurality of fixing pins (not shown) and the like in a state that the outrigger 236 coupled to the lower truss unit 231 is moved to a position where it can be reached.

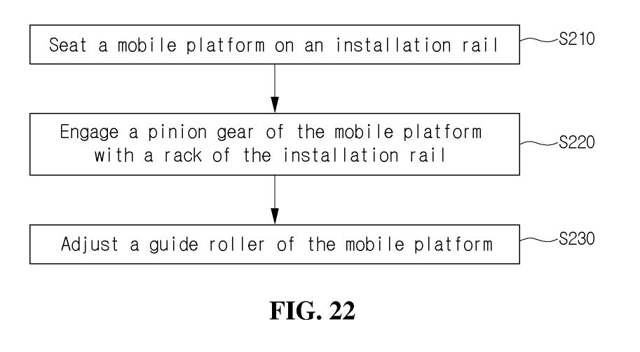

FIG. 22 is a process diagram for explaining a mobile platform installation step in the method for installing the gantry tower crane for use in the cargo hold inspection according to the preferred embodiment of the present invention.

As shown in FIGS. 1, 2, 17, 18, 19, and 22, in step S200, the first prefabricated tower and the second prefabricated tower, which are two prefabricated towers 200, may be movably mounted on the installation rail 130 of the cargo hold 10, and the mobile platform 210 capable of moving the prefabricated tower 200 may be inserted and installed.

The mobile platform 210 inserted into the cargo hold 10 may be movably mounted on the installation rail 130.

The mobile platform installation step may include: a step S210 of seating the mobile platform 210, which is inserted by the crane (not shown) on the installation rail 130; a step S220 of engaging a pinion gear 214, which is mounted on the mobile platform 210 during the seating of the mobile platform 210, with a rack 132 mounted on the installation rail 130; and a step S230 of adjusting guide rollers 215 mounted on both side surfaces of the mobile platform 210 such that the guide rollers 215 make close contact with the running rail 130.

In order to allow the prefabricated tower 200 to move along the installation rail 130, the mobile platform 210 is inserted into the cargo hold 10 and the tower unit 230 is assembled and descended, so that the mobile platform 310 and the tower unit 230 are coupled to each other.

The mobile platform 210 may be inserted and lowered inside the cargo hold 10 by using the crane. At this time, two mobile platforms 210 may be inserted.

In step S210, the inserted mobile platform 210 is seated on the installation rail 130.

In step S220, the mobile platform 210 seated on the installation rail 130 may be coupled to the installation rail 130, such that the pinion gear 214 mounted on the platform body 211 and the rack 132 provided on the installation rail 130 are engaged with each other.

In addition, in step S230, a position of the guide roller 215 may be adjusted by the installation rail 130 and the mobile platform 210 to move the mobile platform 210 in a more stable posture when the mobile platform 210 moves.

As shown in FIG. 7, the adjustment bolt 218 installed on the side surface of the mobile platform 210 is rotated, and the guide member 216 makes close contact with the side surface of the installation rail 130 with the movement of the movable body 217 by the rotation of the adjustment bolt 218.

The adjustment of the guide roller 215 may be controlled by the adjustment bolt 218 protruding from the side surface of the mobile platform 210. In other words, the operator rotates the adjustment bolt 218 protruding from the side surface of the mobile platform 210.

Accordingly, the movable body 217 fastened to the adjustment bolt 218 moves to the side surface of the mobile platform 210. As the adjustment bolt 218 is fastened to the movable body 217, the guide member 216 coupled to the inside the movable body 217 is moved.

The moved guide member 216 protrudes outward of the mobile platform 210 or moves inward of the mobile platform 210 according to the rotation direction of the adjustment bolt 218. As the guide member 216 protrudes to the outside of the mobile platform 210, the guide member 216 makes close contact with the guide rail 133 of the installation rail 130.

As described above, as the guide member 216 makes close contact with the guide rail 133 of the installation rail 130, the mobile platform 210 may move in a more stable state.

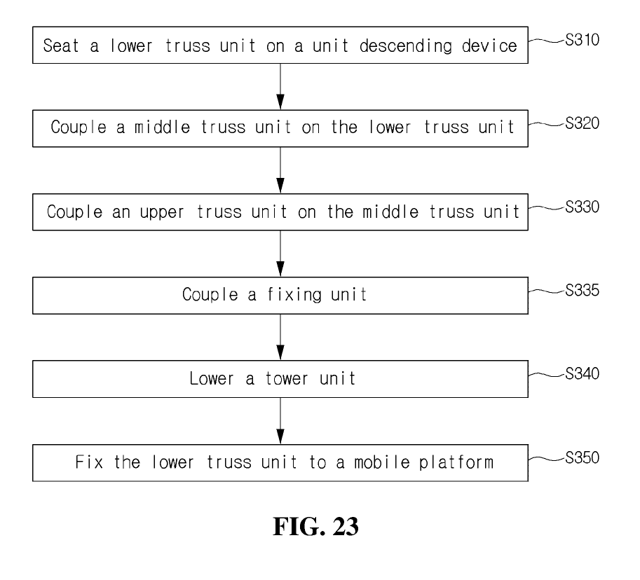

FIG. 23 is a process diagram for explaining a prefabricated tower installation step in the method for installing the gantry tower crane for use in the cargo hold inspection according to the preferred embodiment of the present invention.

As shown in FIGS. 18, 19, and 23, the mobile platform 210 may be provided with the prefabricated tower 200 by assembling the tower unit 230 with the fixing unit 250.

In step S300, the prefabricated tower 200 may be assembled by coupling the tower unit 230 and the mobile platform 210 that are lowered while being assembled by the unit descending device 500.

The prefabricated tower installation step may include: a step S310 of seating a lower truss unit 231 on the unit descending device 500; a step S320 of coupling a middle truss unit 237 to an upper surface of the lower truss unit 231 seated on the unit descending device 500; a step S330 of repeatedly assembling and lowering another middle truss unit 237 on an upper surface of the middle truss unit 237; a step S335 of coupling an upper truss unit 242 and the fixing unit 250 to an upper end of the middle truss unit 237; a step S340 of lowering the tower unit 230 that has been assembled by the unit descending device 500; and a step S350 of fixing the lower truss unit 231 of the tower unit 230 to a post 212 of the mobile platform 210.

When moving the prefabricated tower 200, the outrigger 236 provided on the tower unit 230 may be movably coupled to the auxiliary installation rail 140 spaced apart from the installation rail 130 by a predetermined distance.

In step S310, the lower truss unit 231 is seated on the unit descending device 500, and the lower truss unit 231 maintains a seated state by the first cylinder 521 or the second cylinder 522 of the unit descending device 500.

In step S320, the middle truss unit 237 is coupled to the upper portion of the lower truss unit 231. In other words, the middle truss unit 237 may be fitted to the coupling hole 235 in the upper portion of the lower truss unit 231, and then fixed by fitting the fixing pin (not shown).

In step S330, a plurality of middle truss units 237 are provided, the middle truss units 237 are assembled and fixed to each other, and when the middle truss unit 237 is coupled, the unit descending device 500 descends the tower unit 230 while the first cylinder 521 and the second cylinder 522 are alternately moved up and down.

In step S335, the upper truss unit 242 and the fixing unit 250 are firmly coupled to the upper end of the middle truss unit 237. The tower unit 230 including the lower truss unit 231, the middle truss unit 537, the upper truss unit 242, and the fixing unit 250 is sequentially lowered while being assembled by the unit descending device 500.

In step S350, the tower unit 230 lowered by the unit descending device 500 is fixed to the mobile platform 210 mounted on the installation rail 130.

The fixing hole 234 formed in the lower truss unit 231 of the tower unit 230 is aligned with the hole 213 of the mobile platform 210, and then fixed with the fixing pin and the like.

In addition, the prefabricated tower 200 in which the mobile platform 210, the tower unit 230 and the fixing unit 250 are integrated unfolds the outrigger 236 so as to be stably moved when moving along the installation rail 130.

The outrigger 236 is coupled to the auxiliary installation rail 140 spaced apart from the installation rail 130 by a predetermined distance to move the prefabricated 200 more safely.

In step S400, the prefabricated tower 200 in which the mobile platform 210, the tower unit 230 and the fixing unit 250 are integrated may be provided at both sides thereof with the running rails 150 as the running rails 150 coupled to the tower unit 230 are lowered.

In other words, the running rail 150 is lowered simultaneously with the tower unit 230 by the crane and the like in a state of being hooked by the rotation bar 241 of the tower unit 230. As the running rail 150 is lifted by the crane and the like, the rotation bar 241 is rotated inwards of the middle truss unit 237 by the elastic force of the spring (not shown), so that the running rail 150 and the tower unit 230 are separated from each other.

Since the running rail 150 is provided with the moving wheels 154, the running rail 150 is installed along the floor surface of the cargo hold 10 at both ends of the installation rail 130 in the longitudinal direction of the cargo hold 10.

At this time, as for the two prefabricated towers 200, the running rail 150 is installed after the tower unit 230 and the fixing unit 250 are installed on the mobile platform 210 in the first prefabricated tower.

In addition, during the installation of the running rail 150 of the first prefabricated tower, the unit descending device 500 assembles and lowers the tower unit 230, the upper truss unit 242, and the fixing unit 250 so as to install the second prefabricated tower.

In other words, steps S310 to S350 are repeated, and accordingly, the work time required for assembling and installing the second prefabricated tower 200 can be remarkably reduced.

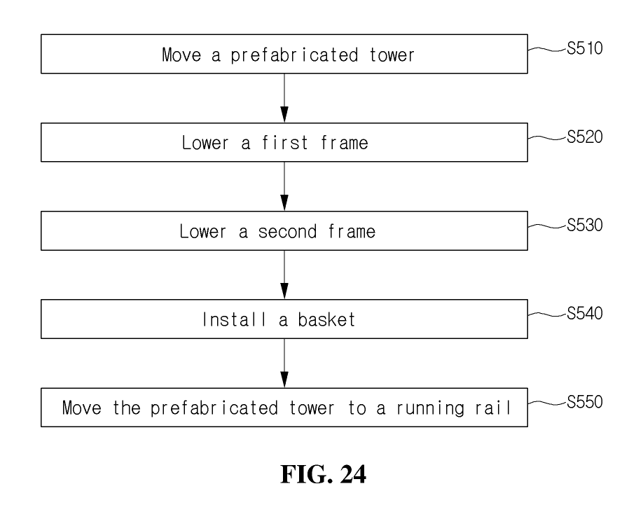

FIG. 24 is a process diagram for explaining a basket installation step in the method for installing the gantry tower crane for use in the cargo hold inspection according to the preferred embodiment of the present invention.

As shown in FIG. 24, in step S500, the basket 300 having a space allowing the operator to ride and work may be installed between the prefabricated towers 200.

The basket installation step may include: a step S510 of moving the prefabricated tower 200 to a position of the gas dome of the cargo hold 10 so as to install the basket 300 on the prefabricated tower 200; a step S520 of lowering a first frame 311 of an up-down movement frame 310 such that the first frame 311 is movable on an outer surface of the prefabricated tower 200; a step S530 of lowering a second frame 312 of the up-down movement frame 310 such that the second frame 312 is movable on the outer surface of the prefabricated tower 200; a step S540 of installing the first frame 311 and the second frame 312 to allow the first frame 311 and the second frame 312 to move up and down on an outside of the prefabricated tower 200; and a step S550 of moving the prefabricated tower 200 installed with the basket 300 to the running rail 150.

In step S510, the prefabricated tower 200 is moved to the position of the gas dome by the mobile platform 210.

This is performed to install the basket 300 on which the operator may ride in the first and second prefabricated towers, which are two prefabricated towers 200.

In addition, after the basket 300 is installed on the first prefabricated tower, the first prefabricated tower is moved to the running rail 150, and the second prefabricated tower is moved to the position of the gas dome to install the basket 300.

The basket 300 is lowered into the cargo hold 10 through the gas dome by integrating the boom support 330 and the work table 350 in the second frame 312, and the first frame 3111 corresponding to the second frame 312 is lowered to integrally assemble the frames, thereby installing the basket 300.

In step S20, the first frame 311 is lowered through the gas dome while the prefabricated tower 200 is moved to the position of the gas dome.

Meanwhile, the lowering of the first frame 311 and the second frame 312 may be achieved by firstly lowering the first frame 311 by the crane and temporarily hooking the first frame 311 on the winch 253 installed on the prefabricated tower 200.

In addition, in step S530, the boom support 330 and the work table 350 are integrally assembled to the second frame 312 and lowered by the crane through the gas dome.

In step S540, the lowered first and second frames 311 and 312 are integrally assembled with fixing devices such as a pin or a bolt in a state of making contact with each other, thereby installing the basket 300 on the prefabricated tower 200.

Since the basket 300 is provided with a plurality of wheels 313 on the first frame 311 and the second frame 312, the basket 300 may be freely moved up and down by the winch 253.

The first prefabricated tower in which the basket 300 is assembled is moved along the running rail 150, and at this time, the prefabricated tower 200 may move in a more stable state by coupling the outrigger 236 to the auxiliary installation rail 140.

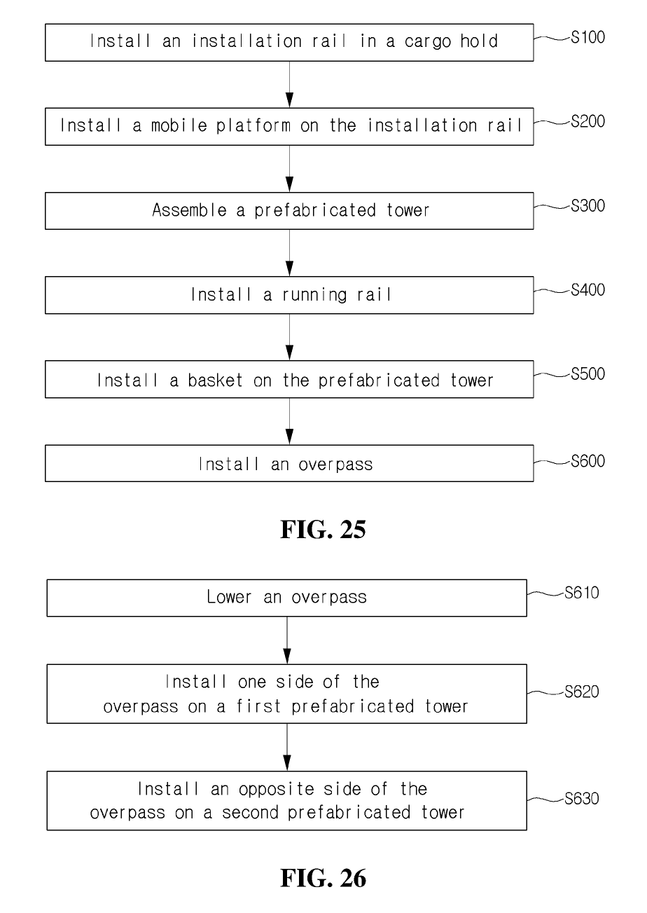

FIG. 25 is a process diagram for explaining an overpass installation step in the method for installing the gantry tower crane for use in the cargo hold inspection according to the preferred embodiment of the present invention, and FIG. 26 is a process diagram for explaining the overpass installation step in the method for installing the gantry tower crane for use in the cargo hold inspection according to the preferred embodiment of the present invention.

As shown in FIGS. 25 and 26, in step S600, the overpass 400 may be installed between the prefabricated towers 200. Since steps from the step of installing the installation rail 130 to the step of installing the basket 300 on the prefabricated tower 200 are the same, the duplicated description will be omitted.

The overpass installation step may include: a step S610 of assembling and descending the overpass 400 separated into a plurality of pieces; a step S620 of connecting (installing) one side of the overpass 400, which is inserted into the cargo hold 10, to one of the prefabricated towers 200; and a step S630 of connecting (installing) the other side of the overpass 400, which is inserted into the cargo hold 10, to the remaining one of the prefabricated towers 200.

In step S610, the overpass 400 mounted on the unit descending device 500 is brought into alignment with the overpass 400 moved by the crane, and the overpasses 400 are lowered while being assembled by the fixing devices such as the fixing pin.

In this manner, in step S620, one side of the overpass 400 inserted into the cargo hold 10 may be connected (installed) to the first prefabricated tower by the winch 253. In addition, the other side of the overpass 400 may be connected (installed) to the second prefabricated tower.

The installed gantry tower crane may move along the running rail 150 in the longitudinal direction of the cargo hold 10, and the basket 300 may be vertically moved up and down by the winch 253 installed in the prefabricated tower 200.

In addition, the boom support 330 of the basket 300 may have a length varied along the wall surface of the cargo hold 10, and the work table 350 may be freely rotated by the rotation boom support 331.

In addition, the upper truss unit 242 is opened to communicate with the overpass 400, so that the operator can freely move as necessary.

Although the present invention invented by the present inventor has been described in detail with reference to the embodiments, the present invention is not limited to the above embodiments, and various modifications are possible without departing from the scope and spirit of the present invention.

1. A gantry tower crane for inspecting a cargo hold, the gantry tower crane comprising:
two running rails spaced apart from each other in a longitudinal direction of the cargo hold;
two prefabricated towers movably mounted along the running rails, respectively; and
a basket movable up and down along the prefabricated tower,
wherein the running rail comprises a rail body having a predetermined length and a predetermined width,
wherein the rail body comprises:
a first coupling part coupled with another rail body adjacent to one side of the rail body; and
a second coupling part coupled with another rail body adjacent to an opposite side of the rail body,
wherein a plurality of rail bodies are coupled to each other by the coupling of the first and second coupling parts.

2. The gantry tower crane of claim 1, further comprising an overpass connected between the two prefabricated towers widthwise along the cargo hold.

3. The gantry tower crane of claim 1, wherein the running rail further comprises:
a rack mounted on an upper surface of the rail body to allow the prefabricated tower to move; and
a guide rail mounted in a same direction as the rack at a position spaced apart from the rack by a predetermined distance.

4. The gantry tower crane of claim 3, wherein the running rail comprises a plurality of moving wheels mounted on a bottom surface of the rail body so as to be movable along a floor surface of the cargo hold.

5. (canceled)

6. (canceled)

7. The gantry tower crane of claim 3, wherein the prefabricated tower comprises:
a mobile platform movably mounted along the running rail; and
a plurality of tower units vertically coupled to the mobile platform.

8. The gantry tower crane of claim 7, wherein the mobile platform comprises:
a platform body having a predetermined size;
a plurality of posts vertically fixed to an upper portion of the platform body such that the posts are coupled with the tower unit; and
a plurality of pinion gears mounted on a bottom surface of the platform body such that the pinion gears are engaged with the rack so as to be movable along the running rail.

9. (canceled)

10. (canceled)

11. (canceled)

12. The gantry tower crane of claim 7, wherein the tower unit comprises:
a lower truss unit coupled to the mobile platform;
at least one middle truss unit coupled to an upper portion of the lower truss unit; and
an upper truss unit coupled to an uppermost end of the middle truss unit and provided with a passage for an operator.

13. (canceled)

14. (canceled)

15. (canceled)

16. The gantry tower crane of claim 7, wherein the prefabricated tower comprises a fixing unit making close contact with an upper surface of the cargo hold to stably mount the tower unit.

17. (canceled)

18. (canceled)

19. (canceled)

20. The gantry tower crane of claim 1, wherein the basket is rotatable in a horizontal direction and has a variable length with respect to a wall surface of the cargo hold.

21. The gantry tower crane of claim 20, wherein the basket comprises:
an up-down movement frame mounted on an outer surface of the prefabricated tower so as to be movable up and down;
a boom support rotatably mounted on one surface of the up-down movement frame and having a variable length; and
a work table rotatably mounted at an end of the boom support.

22. (canceled)

23. (canceled)

24. (canceled)

25. The gantry tower crane of claim 1, wherein the prefabricated tower comprises:
a mobile platform movably mounted along the running rail; and
a plurality of tower units vertically coupled to the mobile platform.

26. The gantry tower crane of claim 25, wherein the prefabricated tower comprises a fixing unit making close contact with a ceiling of the cargo hold so as to stably mount the tower unit.

27. The gantry tower crane of claim 2, wherein the overpass comprises:
a foothold serving as a path for an operator;
a foothold support having a truss structure to stably support the foothold; and
an auxiliary foothold rotatable toward an outside such that a work space extends on one side of the foothold.

28. The gantry tower crane of claim 27, wherein the foothold comprises:
a foothold body rotatable about a hinge; and
a rotation link provided at predetermined intervals on both sides of the foothold body.

29. The gantry tower crane of claim 27, wherein the foothold is hinge-coupled so as to be folded or unfolded.

30. (canceled)

31. (canceled)

32. (canceled)

33. (canceled)

34. (canceled)

35. (canceled)
